(19) United States
(12) Patent Application Publication
(10) Pub. No.: US 2012/0233406 A1
(43) Pub. Date: Sep. 13, 2012

(54) STORAGE APPARATUS, AND CONTROL METHOD AND CONTROL APPARATUS THEREFOR

(75) Inventors: Atsushi Igashira, Kawasaki (JP); Norihide Kubota, Kawasaki (JP); Kenji Kobayashi, Kawasaki (JP); Ryota Tsukahara, Kawasaki (JP); Hidejirou Daikokuya, Kawasaki (JP); Kazuhiko Ikeuchi, Kawasaki (JP); Chikashi Maeda, Kawasaki (JP)

(73) Assignee: FUJITSU LIMITED, Kawasaki-shi (JP)

(21) Appl. No.: 13/404,106

(22) Filed: Feb. 24, 2012

(30) Foreign Application Priority Data
Mar. 7, 2011 (JP) 2011-048506

(51) Int. Cl. G06F 12/08

(52) U.S. Cl. 711/118; 711/E12.017

(57) ABSTRACT

A control apparatus, coupled to a storage medium via communication links, controls data write operations to the storage medium. A cache memory is configured to store a temporary copy of first data written in the storage medium. A processor receives second data with which the first data in the storage medium is to be updated, and determines whether the received second data coincides with the first data, based on comparison data read out of the storage medium, when no copy of the first data is found in the cache memory. When the second data is determined to coincide with the first data, the processor determines not to write the second data into the storage medium.

### CROSS-REFERENCE TO RELATED APPLICATION

This application is based upon and claims the benefit of priority of the prior Japanese Patent Application No. 2011-048506, filed on Mar. 7, 2011, the entire contents of which are incorporated herein by reference.

### FIELD

The embodiments discussed herein relate to a storage apparatus, as well as to a control method and control apparatus therefor.

### BACKGROUND

Computer systems of today are often used with a storage apparatus formed from a plurality of mass storage devices to store a large amount of data. A typical storage apparatus includes one or more storage media and a controller that controls the operation of writing and reading data in the storage media. See, for example, Japanese Laid-open Patent Publication No. 2007-87094.

Such storage apparatuses may be used for the purpose of data backup. An existing backup technique skips unchanged data and minimizes the number of copies of each file to be backed up, thereby reducing the amount of data to be backed up. According to this technique, a processor assesses data, stored in a memory, to be backed up and determines whether and what data to back up. Data for storage is transferred to a backup storage only if the data that needs backup is absent in a cache memory. See, for example, Japanese National Publication of International Patent Application, No. 2005-502956.

Backup source data resides in data storage media even when it is not found in the cache memory. Suppose, for example, the case where the cache memory is too small to accommodate backup source data. In this case, most part of the backup source data is absent in the cache memory. The method mentioned above transfers data for storage to storage media only if backup source data is absent in a cache memory. This method, however, overwrites existing data in data storage media even if that existing data is identical to the backup source data.

### SUMMARY

According to an aspect of the invention, there is provided a control apparatus for controlling data write operations to a storage medium. This control apparatus includes a cache memory configured to store a temporary copy of first data written in the storage medium; and a processor configured to perform a procedure of: receiving second data with which the first data in the storage medium is to be updated, determining, upon reception of the second data, whether the received second data coincides with the first data, based on comparison data read out of the storage medium, when no copy of the first data is found in the cache memory, and determining not to write the second data into the storage medium when the second data is determined to coincide with the first data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a storage apparatus according to a first embodiment;

FIG. 2 is a block diagram illustrating a data storage system according to a second embodiment;

FIG. 3 illustrates a bandwidth-write scheme;

FIG. 4 illustrates a read & bandwidth-write scheme;

FIG. 5 illustrates a first small-write scheme;

FIG. 6 illustrates a second small-write scheme;

FIG. 7 is a functional block diagram of a controller module according to the second embodiment;

FIG. 8 is a flowchart illustrating data write operations performed by the controller module;

FIG. 9 is a flowchart illustrating a first write decision routine using a bandwidth-write scheme;

FIG. 10 is a flowchart illustrating a first write decision routine using a read & bandwidth-write scheme;

FIG. 11 is a flowchart illustrating a first write decision routine using a first small-write scheme;

FIG. 12 is a flowchart illustrating a first write decision routine using a second small-write scheme;

FIG. 13 is a flowchart illustrating a second write decision routine using a bandwidth-write scheme;

FIG. 14 is a flowchart illustrating a second write decision routine using a read & bandwidth-write scheme;

FIG. 15 is a flowchart illustrating a second write decision routine using a first small-write scheme;

FIG. 16 is a flowchart illustrating a second write decision routine using a second small-write scheme;

FIG. 17 illustrates a specific example of the first write decision routine using a bandwidth-write scheme;

FIG. 18 illustrates a specific example of the first write decision routine using a read & bandwidth-write scheme;

FIG. 19 illustrates a specific example of the first write decision routine using a first small-write scheme;

FIG. 20 illustrates a specific example of the first write decision routine using a second small-write scheme;

FIG. 21 illustrates a specific example of the second write decision routine using a bandwidth-write scheme;

FIG. 22 illustrates a specific example of the second write decision routine using a read & bandwidth-write scheme;

FIG. 23 illustrates a specific example of the second write decision routine using a first small-write scheme;

FIG. 24 illustrates a specific example of the second write decision routine using a second small-write scheme;

FIG. 25 illustrates an example application of the storage apparatus according to the second embodiment;

FIG. 26 illustrates a deduplex & copy scheme;

FIG. 27 illustrates a background copy scheme; and

FIG. 28 illustrates a copy-on-write scheme.

### DESCRIPTION OF EMBODIMENTS

Several embodiments of a storage apparatus will be described below with reference to the accompanying drawings, wherein like reference numerals refer to like elements throughout.

### (a) First Embodiment

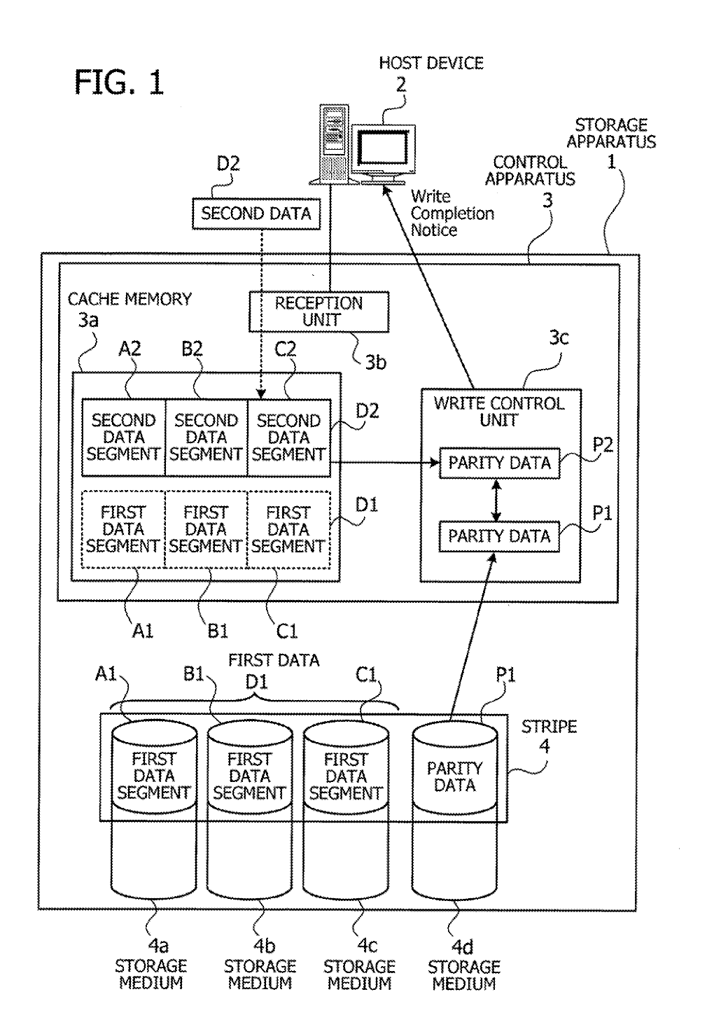

FIG. 1 illustrates a storage apparatus according to a first embodiment. This storage apparatus 1 of the first embodiment is coupled to a host device 2 via an electronic or optical link or other communication channels. The illustrated storage apparatus 1 includes a control apparatus 3 and a plurality of storage media 4a, 4b, 4c, and 4d. Those storage media 4a, 4b, 4c, and 4d are configured to provide storage spaces for storing data. The storage media 4a, 4b, 4c, and 4d may be implemented by using, for example, hard disk drives (HDD) or solid state drives (SSD) or both. The total data capacity of the storage media 4a, 4b, 4c, and 4d may be, but not limited to, 600 gigabytes (GB) to 240 terabytes (TB), for example. The first embodiment described herein assumes that the storage apparatus 1 includes four storage media 4a, 4b, 4c, and 4d, while it may be modified to have three or fewer media or, alternatively, five or more media.

A stripe 4 has been defined as a collection of storage spaces each in a different storage medium 4a, 4b, 4c, and 4d. These storage spaces contain first data D1 in such a way that the first data D1 is divided into smaller units with a specific data size and distributed in different storage media 4a, 4b, and 4c. Those distributed data units is referred to as “data segments” A1, B1, and C1. According to the first embodiment, each data segment is a part of write data that has been written from the host device 2, and the data size of a data segment may be equivalent to the space of 128 logical block addresses (LBA), where each LBA specifies a storage space of 512 bytes, for example.

The first data D1 has been written in the storage media 4a, 4b, and 4c in response to, for example, a write request from the host device 2. Specifically, one storage medium 4a stores one data segment A1 of the first data D1 in its storage space allocated to the stripe 4. Another storage medium 4b stores another data segment B1 of the first data D1 in its storage space allocated to the stripe 4. Yet another storage medium 4c stores yet another data segment C1 of the first data D1 in its storage space allocated to the stripe 4. Further, still another storage medium 4d stores parity data P1 (error correction code) in its storage space allocated to the stripe 4. This parity data has been produced from the above data segments A1, B1, and C1 for the purpose of ensuring their redundancy.

The control apparatus 3 writes data in storage spaces of the storage media 4a, 4b, 4c, and 4d on a stripe-by-stripe basis in response to, for example, a data write request from the host device 2. To this end, the control apparatus 3 includes a cache memory 3a, a reception unit 3b, and a write control unit 3c.

For example, the cache memory 3a may be implemented as part of static random-access memory (SRAM, not illustrated) or dynamic random-access memory (DRAM, not illustrated) in the control apparatus 3. The capacity of this cache memory 3a may be, but not limited to, 2 GB to 64 GB, for example.

The cache memory 3a is provided for the purpose of accelerating read and write I/O operations (hereafter, simply referred to as “access”) between the host device 2 and control apparatus 3, for example. That is, the cache memory 3a temporarily stores write data addressed to the storage media 4a, 4b, 4c, and 4d when there is a write access request from the host device 2. The cache memory 3a also stores read data retrieved from the storage media 4a, 4b, 4c, and 4d when there is a read access request from the host device 2. With such temporary storage of data, the cache memory 3a permits the host device 2 to reach the data in subsequent read access without the need for making access to the storage media 4a, 4b, 4c, and 4d.

The cache memory 3a, however, is smaller in capacity than the storage media 4a, 4b, 4c, and 4d. It is therefore not possible to load the cache memory 3a with every piece of data stored in the storage media 4a, 4b, 4c, and 4d. The cache memory 3a is thus designed to discard less-frequently used data to provide a space for storing new data.

The reception unit 3b and write control unit 3c may be implemented as part of the functions performed by a processor such as a central processing unit (CPU, not illustrated) in the control apparatus 3. The reception unit 3b receives second data D2 which is intended to update the first data D1 in the storage medium 4a, 4b, and 4c. Specifically, whether the second data D2 is to update the first data D1 is determined by, for example, testing whether the destination of second data D2 matches with where the first data D1 is stored. The reception unit 3b puts the received second data D2 in the cache memory 3a as temporary storage.

The write control unit 3c determines whether the cache memory 3a has an existing entry of the first data D1, before writing the received second data D2 into the storage medium 4a, 4b, and 4c. In other words, the write control unit 3c determines whether there is a cache hit for the first data D1. The term “cache hit” is used here to mean that the cache memory 3a contains data necessary for executing instructions, and that the data is ready for read access for that purpose. The determination of cache hit may alternatively be done by the reception unit 3b immediately upon receipt of second data D2.

The dotted-line boxes seen in the cache memory 3a of FIG. 1 indicate that the cache memory 3a had an entry for data segments A1, B1, and C1 of the first data D1 when there was an access interaction between the host device 2 and control apparatus 3. That cache entry of the first data D1 was then overwritten with some other data and is not existent in the cache memory 3a at the time of determination of cache hits by the write control unit 3c. More specifically in the example of FIG. 1, the write control unit 3c makes this determination when writing second data D2 in storage media 4a, 4b, and 4c, and learns from a cache management table (not illustrated) that there is no cache entry for the first data D1. According to this determination, the write control unit 3c reads parity data P1 out of the storage medium 4d. This parity data P1 may be regarded as an example of “comparison data” used for comparison between two pieces of data. By using the parity data P1 read out of the storage medium 4d, the write control unit 3c determines whether the first data D1 coincides with the second data D2. This parity-based comparison between D1 and D2 may be performed through, for example, the following steps.

The write control unit 3c produces data segments A2, B2, and C2 from second data D2 in the cache memory 3a. These data segments A2, B2, and C2 constitute a stripe 4 across the storage media 4a, 4b, and 4c to store the second data D2 in a distributed manner. The write control unit 3c then calculates an exclusive logical sum (exclusive OR, or XOR) of the produced data segments A2, B2, and C2. The calculation result is used as parity data P2 for ensuring redundancy of the data segments A2, B2, and C2. The write control unit 3c now compares the two pieces of parity data P1 and P2. When P1 coincides with P2, the write control unit 3c determines that the second data D2 coincides with the first data D1.

Now that the second data D2 is found to coincide with the first data D1, the write control unit 3c determines not to write the second data D2 into the storage media 4a, 4b, and 4c. This avoidance of write operation prevents the existing stripe 4 of first data D1 in the storage media 4a, 4b, and 4c from being overwritten with the second data D2 having the same values. While no write operation occurs, the write control unit 3c may then inform the host device 2 that the second data D2 has successfully been written in the storage media 4a, 4b, and 4c.

When, on the other hand, the two pieces of parity data P1 and P2 do not coincide with each other, the write control unit 3c interprets it as a mismatch between the first data D1 and second data D2. In this case, the write control unit 3c actually writes the second data D2 in the storage media 4a, 4b, and 4c. Specifically, the write control unit 3c stores a data segment A2 in the storage medium 4a by overwriting its storage space allocated to the stripe 4. The write control unit 3c also stores another data segment B2 in the storage medium 4b by overwriting its storage space allocated to the stripe 4. Similarly the write control unit 3c stores yet another data segment C2 in the storage medium 4c by overwriting its storage space allocated to the stripe 4. The write control unit 3c further stores parity data P2 in the storage medium 4d by overwriting its storage space allocated to the stripe 4. As a result of these overwrite operations, the previous data stored in each storage space of the stripe 4 is replaced with new content.

While not depicted in FIG. 1, the write control unit 3c may be configured to determine whether second data D2 coincides with first data D1 before writing the second data D2 in storage media 4a, 4b, and 4c, in the case where the first data D1 is found to be in the cache memory 3a. For example, this determination of data coincidence may be performed in the following way.

The write control unit 3c calculates XOR of data segments A1, B1, and C1 in the cache memory 3a. The calculation result is referred to as “cache parity data” for ensuring data redundancy of the data segments A1, B1, and C1. This cache parity data may be regarded as an example of “comparison data” used for comparison between given data with a cache entry. The write control unit 3c also produces data segments A2, B2, and C2 from the received second data D2 and calculates their XOR to produce parity data P2 for ensuring data redundancy of the data segments A2, B2, and C2. The write control unit 3c now compares this parity data P2 with the above cache parity data. When the parity data P2 coincides with the cache parity data, the write control unit 3c determines that the second data D2 coincides with the first data D1. The write control unit 3c determines not to write the second data D2 into the storage media 4a, 4b, and 4c since it has turned out to be equal to the first data D1. The avoidance of write operation prevents the existing stripe 4 of first data D1 in the storage media 4a, 4b, and 4c from being overwritten with the second data D2 having the same values.

When, on the other hand, the parity data P2 does not coincide with the cache parity data, the write control unit 3c interprets it as a mismatch between the first data D1 and second data D2. In this case, the write control unit 3c actually writes the second data D2 in storage media 4a, 4b, and 4c. Specifically, the write control unit 3c stores a data segment A2 in the storage medium 4a by overwriting its storage space allocated to the stripe 4. The write control unit 3c also stores another data segment B2 in the storage medium 4b by overwriting its storage space allocated to the stripe 4. Similarly the write control unit 3c stores yet another data segment C2 in the storage medium 4c by overwriting its storage space allocated to the stripe 4. The write control unit 3c further stores parity data P2 in the storage medium 4d by overwriting its storage space allocated to the stripe 4. As a result of these overwrite operations, the previous data stored in each storage space of the stripe 4 is replaced with new content.

In operation of the control apparatus 3 according to the first embodiment, the write control unit 3c compares first data D1 with second data D2 by using parity data P1 read out of a storage medium 4d when the cache memory 3a contains no entry for the first data D1. The write control unit 3c determines not to write the second data D2 into storage media 4a, 4b, and 4c when it is determined that the second data D2 coincides with the first data D1.

When data is received from a host device 2, and if there is no existing cache entry for comparison with that data, some other control apparatus would write the received data in storage media right away. In contrast, the control apparatus 3 makes it more possible to avoid duplicated write operations for the same data, thus reducing the frequency of write operations on storage media 4a, 4b, 4c, and 4d. This reduction constitutes an advantage particularly when, for example, SSDs are used in the storage media 4a, 4b, 4c, and 4d, since SSDs are limited by a finite number of program-erase cycles. That is, it is possible to extend the life time of those SSDs.

It is noted that read access to storage media 4a, 4b, and 4c is faster than write access to the same. In other words, it takes less time for the control apparatus 3 to read first data D1 from storage media 4a, 4b, and 4c than to write second data D2 into the same. The above-noted avoidance of duplicated write operations enables the control apparatus 3 to process the second data D2 from the host device 2 in a shorter time.

The write control unit 3c is designed to determine whether the first data D1 coincides with the second data D2 by using their respective parity data P1 and P2. This determination is achieved through a single operation of comparing parity data P1 with parity data P2, as opposed to multiple operations of comparing individual data segments A1, B1, and C1 with their corresponding data segments. This reduction in the number of comparisons permits the control apparatus 3 to process the second data D2 in a shorter time.

The control apparatus 3 may write new parity data P2 in the storage medium 4d as part of the stripe 4 when it does not coincide with the existing parity data. Matching between the first data D1 and second data D2 may alternatively be performed by using, for example, their hash values calculated for comparison. But this alternative method has to produce parity data P2 when the hash comparison ends up with a mismatch. In contrast, in the case of the parity-based data matching, the control apparatus 3 already has the parity data to write. In other words, the present embodiment uses the parity data not only for redundancy purposes, but also for data comparison purposes, and thus eliminates the need for producing other data codes dedicated to comparison. The next sections of the description will provide more details about the proposed storage apparatus.

### (b) Second Embodiment

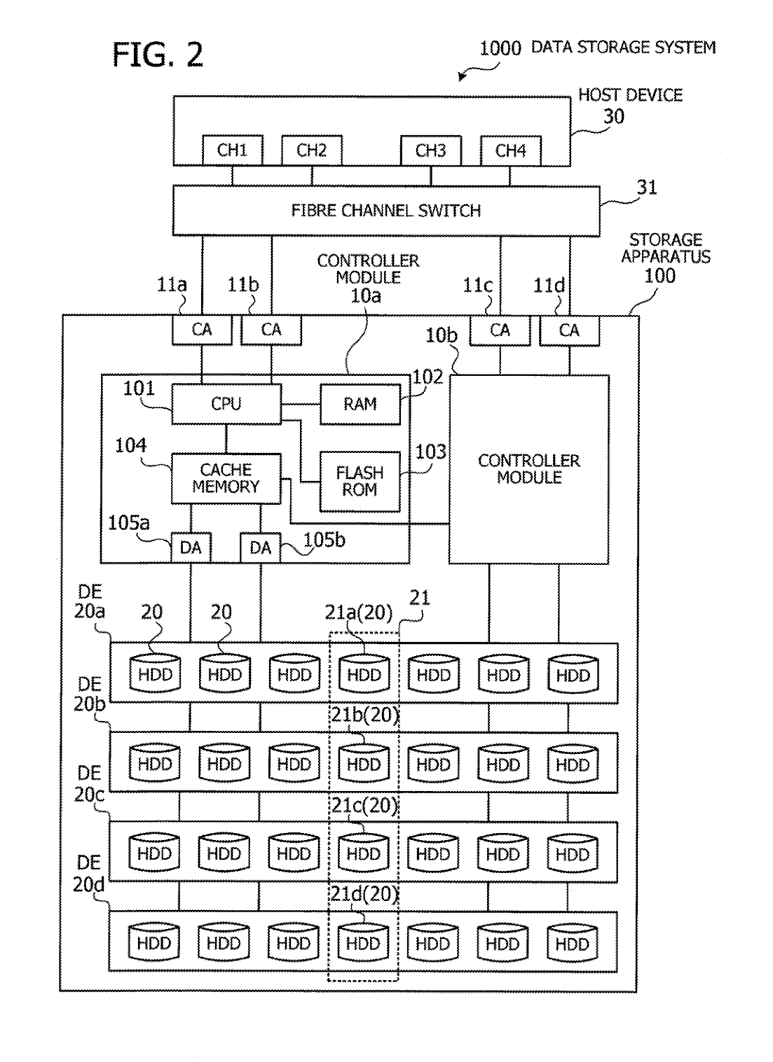

FIG. 2 is a block diagram illustrating a data storage system according to a second embodiment. The illustrated data storage system 1000 includes a host device 30 and a storage apparatus 100 coupled to the host device 30 via a Fibre Channel (FC) switch 31. While FIG. 2 depicts only one host device 30 linked to the storage apparatus 100, the second embodiment may also apply to other cases in which a plurality of host devices are linked to the storage apparatus 100.

The storage apparatus 100 includes a plurality of drive enclosures (DE) 20a, 20b, 20c, and 20d and controller modules (CM) 10a and 10b for them. Each drive enclosure 20a, 20b, 20c, and 20d includes a plurality of HDDs 20. The controller modules 10a and 10b manage physical storage spaces of the drive enclosures 20a, 20b, 20c, and 20d by organizing them in the form of a redundant array of independent (or inexpensive) disks (RAID). While the illustrated embodiment assumes the use of HDDs 20 as storage media for drive enclosures 20a, 20b, 20c, and 20d, the second embodiment is not limited by this specific type of media. For example, SSDs or other type of storage media may be used in place of the HDDs 20. In the following description, the HDDs 20 located in each or all drive enclosures 20a, 20b, 20c, and 20d may be referred to collectively as HDD array(s) 20. The total data capacity of HDD arrays 20 may be in the range of 600 gigabytes (GB) to 240 terabytes (TB), for example.

The storage apparatus 100 ensures redundancy of stored data by employing two controller modules 10a and 10b in its operations. The number of such controller modules is, however, not limited by this specific example. The storage apparatus 100 may employ three or more controller modules for redundancy purposes, or may be controlled by a single controller module 10a.

The controller modules 10a and 10b are each considered as an example implementation of the foregoing control apparatus. The controller modules 10a and 10b have the same hardware configuration. One controller module 10a is coupled to channel adapters (CA) 11a and 11b through its own internal bus. The other controller module 10b is coupled to another set of channel adapters 11c and 11d through its own internal bus.

Those channel adapters 11a, 11b, 11c, and 11d are linked to a fibre Channel switch 31 and further to the channels CH1, CH2, CH3, and CH4 via the fibre Channel switch 31. The channel adapters 11a, 11b, 11c, and 11d provide interface functions for the host device 30 and controller modules 10a and 10b, enabling them to transmit data to each other.

The controller modules 10a and 10b are responsive to data access requests from the host device 30. Upon receipt of such a request, the controller modules 10a and 10b control data access to the physical storage space of HDDs 20 in the drive enclosures 20a, 20b, 20c, and 20d by using RAID techniques. As mentioned above, the two controller modules 10a and 10b have the same hardware configuration. Accordingly the following section will focus on one controller module 10a in describing the controller module hardware.

The illustrated controller module 10a is formed from a CPU 101, a random access memory (RAM) 102, a flash read-only memory (flash ROM) 103, a cache memory 104, and device adapters (DA) 105a and 105b. The CPU 101 centrally controls the controller module 10a in its entirety by executing various programs stored in the flash ROM 103 or other places. The RAM 102 serves as temporary storage for at least part of the programs that the CPU 101 executes, as well as for various data used by the CPU 101 to execute the programs. The flash ROM 103 is a non-volatile memory to store programs that the CPU 101 may execute, as well as various data used by the CPU 101 to execute the programs. The flash ROM 103 may also serve as the location of data that is saved from a cache memory 104 when the power supply to the storage apparatus 100 is interrupted or lost.

The cache memory 104 stores a temporary copy of data that has been written in the HDD arrays 20, as well as of data read out of the HDD arrays 20. When a data read command is received from the host device 30, the controller module 10a determines whether a copy of the requested data is in the cache memory 104. If the cache memory 104 has a copy of the requested data, the controller module 10a reads it out of the cache memory 104 and sends the read data back to the host device 30. This cache hit enables the controller module 10a to respond to the host device 30 faster than retrieving the requested data from the HDD arrays 20 and then sending the data to the requesting host device 30. This cache memory 104 may also serve as temporary storage for data that the CPU 101 uses in its processing. The cache memory 104 may be implemented by using SRAM or other type of volatile semiconductor memory devices. The storage capacity of the cache memory 104 may be, but not limited to, 2 GB to 64 GB, for example.

The device adapters 105a and 105b, each coupled to the drive enclosures 20a, 20b, 20c, and 20d, provide interface functions for exchanging data between the cache memory 104 and HDD arrays 20 constituting the drive enclosures 20a, 20b, 20c, and 20d. That is, the controller module 10a sends data to and receive data from the HDD arrays 20 via those device adapters 105a and 105b.

The two controller modules 10a and 10b are interconnected via a router (not illustrated). Suppose, for example, that the host device 30 sends write data for the HDD arrays 20, and that the controller module 10a receives this data via a channel adapter 11a. The CPU 101 puts the received data into the cache memory 104. At the same time, the CPU 101 also sends the received data to the other controller module 10b via the router mentioned above. The CPU in the receiving controller module 10b receives the data and saves it in its own cache memory. This processing enables the cache memory 104 in one controller module 10a and its counterpart in the other controller module 10b to store the same data.

In the drive enclosures 20a, 20b, 20c, and 20d, RAID groups are each formed from one or more HDDs 20. These RAID groups may also be referred to as “logical volumes,” “virtual disks,” or “RAID logical units (RLU).” For example, FIG. 2 illustrates a RAID group 21 organized in RAID 5 level. The constituent HDDs 20 of this RAID group 21 are designated in FIG. 2 by an additional set of reference numerals (i.e., 21a, 21b, 21c, 21d) to distinguish them from other HDDs 20. That is, the RAID group 21 is formed from HDDs 21a, 21b, 21c, and 21d and operates as a RAID 5 (3+1) system. This configuration of the RAID group 21 is only an example. It is not intended to limit the embodiment by the illustrated RAID configuration. For example, the RAID group 21 may include any number of available HDDs 20 organized in RAID 6 or other RAID levels.

Stripes are defined in the constituent HDDs 21a to 21d of this RAID group 21. These HDDs 21a to 21d allocate a part of their storage spaces to each stripe. The host device 30 sends access requests to the controller modules 10a and 10b, specifying data on a stripe basis. For example, when writing a stripe in the HDDs 21a to 21d, the host device 30 sends the controller modules 10a and 10b new data with a size of one stripe.

The following description will use the term “update data” to refer to stripe-size data that is to be written in storage spaces allocated to a stripe in the HDDs 21a to 21d. This update data may be regarded as an example of what has previously been described as “second data” in the first embodiment.

The following description will also use the term “target data” to refer to data that coincides with the data in storage spaces of HDDs 21a to 21d into which the update data is to be written. That is, the target data may be either (1) data stored in the storage spaces into which the update data is to be written, or (2) data cached in the cache memory 104 which corresponds to the data stored in the storage spaces into which the update data is to be written. This target data may be regarded as an example of what has previously been described as “first data” in the first embodiment.

The following description will further use the term “target stripe” to refer to a stripe that is constituted by storage spaces containing the target data. This target stripe is one of the stripes defined in the storage spaces of HDDs 21a to 21d.

The next section will now describe how the controller modules 10a and 10b write update data into HDDs 21a to 21d. The description focuses on the former controller module 10a since the two controller modules 10a and 10b are identical in their functions.

Upon receipt of update data as a write request from the host device 30, the receiving controller module 10a puts the received update data in its cache memory 104. By analyzing this update data in the cache memory 104, the controller module 10a divides the received update data into blocks with a predetermined data size. In the rest of this description, the term “data segment” is used to refer to such divided blocks of update data. It is assumed here that one data segment is equivalent to a data space of 128 LBAs. Update data is stored in the cache memory 104 as a collection of data segments.

Update data may be written with either an ordinary write-back method or a differential write-back method. Update data may thus have a parameter field specifying which write-back method to use. Alternatively, write-back methods may be specified via a management console or the like. In the latter case, a flag is placed in a predefined location of the cache memory 104 in the controller module 10a to indicate which write-back method to use. The controller module 10a makes access to that flag location to know which method is specified. As another alternative, the controller module 10a may automatically determine the write-back method on the basis of, for example, storage device types (e.g., HDD, SSD). The operator sitting at the host device 30 may also specify an ordinary write-back method or a differential write-back method for use in writing update data.

In the present case, the controller module 10a looks into the update data to determine its write-back method. When it is found that an ordinary write-back method is specified for the received update data, the controller module 10a writes the update data from the cache memory 104 back to the HDDs 21a to 21d during its spare time.

The target stripe is distributed in four storage spaces provided by the HDDs 21a to 21d. According to the configuration of RAID 5 (3+1), three out of those four storage spaces are allocated for data segments of the update data, and the remaining one storage space is used to store parity data. The parity data is produced by the controller module 10a from XOR of those data segments of the update data, for the purpose of redundancy protection. In case of failure in one of the HDDs 21a to 21d (i.e., when it is unable to read data from one of those HDDs 21a to 21d), the parity data would be used to reconstruct stored data without using the failed HDD. The locations of such parity data in the HDDs 21a to 21d vary from stripe to stripe. In this way, the controller module 10a distributes data in separate storage spaces constituting the target stripe in the HDDs 21a to 21d.

On the other hand, when a differential write-back method is specified for the received update data, the controller module 10a then tests whether the update data coincides with its corresponding target data. When the update data is found to coincide with the target data, the controller module 10a determines not to write the update data in any storage spaces constituting the target stripe in the HDDs 21a to 21d. When, on the other hand, the update data is found to be different from the target data, the controller module 10a writes the update data into relevant storage spaces constituting the target stripe in the HDDs 21a to 21d.

The controller module 10a makes a comparison between update data and target data in the following way. The controller module 10a first determines whether the target data resides in the cache memory 104. When no existing cache entry is found for the target data, the controller module 10a then determines whether the update data coincides with target data stored in storage spaces constituting the target stripe, to read the target data from HDDs 21a to 21d.

Specifically, the controller module 10a manages LBA addressing of HDDs 21a to 21d and the address of each cache page of the cache memory 104 which is allocated to the data stored in those LBAs. When the LBA of target data is found in the cache memory 104, the controller module 10a recognizes that the target data resides in the cache memory 104, and thus determines whether the target data in the cache memory 104 coincides with the update data. Then if it is found that the target data in the cache memory 104 coincides with the update data, the controller module 10a determines not to write the update data in any storage spaces constituting the target stripe in the HDDs 21a to 21d. Otherwise, the controller module 10a writes the update data in relevant storage spaces constituting the target stripe in the HDDs 21a to 21d.

When it is found that the update data coincides with target data in storage spaces constituting the target stripe in the HDDs 21a to 21d, the controller module 10a determines not to write the update data in the HDDs 21a to 21d. When the update data is found to be different from target data in storage spaces constituting the target stripe in the HDDs 21a to 21d, the controller module 10a writes the update data in relevant storage spaces constituting the target stripe in the HDDs 21a to 21d.

The above differential write-back method reduces the number of write operations to HDDs 21a to 21d since update data is not actually written when it coincides with data stored in the cache memory 104 or HDDs 21a to 21d. The next section will describe in greater detail how to write update data in storage spaces constituting a target stripe in HDDs 21a to 21d.

When writing update data in HDDs 21a to 21d, the controller module 10a selects one of the following three writing schemes: bandwidth-write scheme, read & bandwidth-write scheme, and small-write scheme. In the following description, the wording “three write operation schemes” refers to the bandwidth-write scheme, read & bandwidth-write scheme, and small-write scheme collectively.

In the foregoing comparison of LBAs, the controller module 10a recognizes the size of given update data and distinguishes which storage spaces of the target stripe in the HDDs 21a to 21d are to be updated with the update data and which storage spaces of the same are not to be changed. The controller module 10a chooses a bandwidth-write scheme when the comparison of LBAs indicates that all the storage spaces constituting the target stripe are to be updated. Using the bandwidth-write scheme, the controller module 10a then writes the update data into those storage spaces in the respective HDDs 21a to 21d.

The controller module 10a chooses a read & bandwidth-write scheme to write given update data into storage spaces constituting its target stripe in the HDDs 21a to 21d when both of the following conditions (1a) and (1b) are true:

(1a) Some storage spaces of the target stripe in the HDDs 21a to 21d are to be updated, while the other storage spaces are not to be updated.

(1b) The number of storage spaces to be updated is greater than that of storage spaces not to be updated.

The controller module 10a chooses a small-write scheme to write given update data into storage spaces constituting a specific target stripe in the HDDs 21a to 21d when both of the following conditions (2a) and (2b) are true:

(2a) Some storage spaces of the target stripe in the HDDs 21a to 21d are to be updated, while the other storage spaces are not to be updated.

(2b) The number of storage spaces to be updated is smaller than that of storage spaces not to be updated.

When the above conditions (2a) and (2b) are true, the controller module 10a further determines which of the following two conditions is true:

(2c) The update data includes no such data that applies only to a part of a storage space.

(2d) The update data includes data that applies only to a part of a storage space.

The following description will use the term “first small-write scheme” to refer to a small-write scheme applied in the case where conditions (2a), (2b), and (2c) are true. The following description will also use the term “second small-write scheme” to refer to a small-write scheme applied in the case where conditions (2a), (2b), and (2d) are true.

It is noted that update data is not always directed to the entire set of data segments. That is, some of the storage spaces constituting a target stripe may not be updated. The controller module 10a selects one of the three write operation schemes depending on the above-described conditions, thereby avoiding unnecessary data write operations to such storage spaces in the HDDs 21a to 21d, and thus alleviating the load on the controller module 10a itself. It is also noted that none of the three write operation schemes is used in the first write operation of data segments to the HDDs 21a to 21d. The first write operation is performed in an ordinary way.

The following sections will describe in detail the bandwidth-write scheme, read & bandwidth-write scheme, and small-write scheme in that order by way of example.

(b1) Bandwidth-Write Scheme

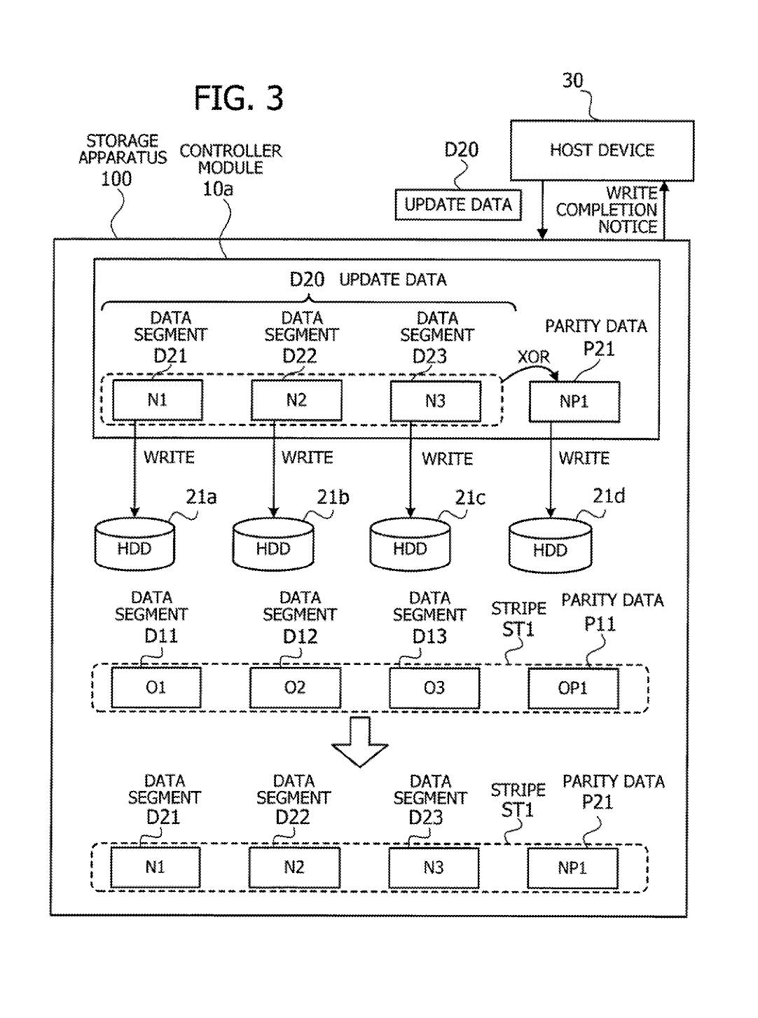

FIG. 3 illustrates a bandwidth-write scheme. Specifically, FIG. 3 illustrates how the controller module 10a handles a write request of update data D20 from a host device 30 to the storage apparatus 100. As can be seen in FIG. 3, a stripe ST1 is formed from storage spaces distributed across four different HDDs 21a to 21d. These storage spaces of stripe ST1 accommodate three data segments D11, D12, and D13, together with parity data P11 for ensuring redundancy of the data segments D11 to D13.

The symbol “O,” as in “O1” in the box representing data segment D11, means that the data is “old” (i.e., there is an existing entry of data). This symbol “O” is followed by numerals “1” to “3” assigned to storage spaces of stripe ST1 for the sake of expediency in the present embodiment. That is, these numerals are used to distinguish storage spaces in different HDDs 21a to 21d from each other. For example, the symbol “O1” affixed to data segment D11 indicates that a piece of old data resides in a storage space of stripe ST1 in the first HDD 21a. The symbol “O2” affixed to data segment D12 indicates that another piece of old data resides in another storage space of stripe ST1 in the second HDD 21b. Similarly, the symbol “O3” affixed to data segment D13 indicates that yet another piece of old data resides in yet another storage space of stripe ST1 in the third HDD 21c. The symbol “OP,” as in “OP1” in the box of parity data P11, means that the content is old (or existing) parity data produced previously from data segments D11 to D13. This symbol “OP” is followed by a numeral “1” representing a specific storage space of stripe ST1 formed across the HDDs 21a to 21d. That is, the symbol “OP1” affixed to parity data P11 indicates that a piece of old parity data resides in still another storage space of stripe ST1 in the fourth HDD 21d.

Upon receipt of a write request of update data D20 from the host device 30, the controller module 10a produces data segments D21, D22, and D23 from the received update data D20. The controller module 10a then calculates XOR of those data segments D21, D22, and D23 to produce parity data P21 for ensuring redundancy of the data segments D21 to D23. The produced data segments D21, D22, and D23 and parity data P21 are stored in the cache memory 104 (not illustrated).

The symbol “N,” as in “N1” in the box representing data segment D21, means that the data is new. This symbol “N” is followed by numerals “1” to “3” assigned to storage spaces constituting stripe ST1 for the sake of expediency in the present embodiment. That is, the numeral “1” indicates that a relevant storage space of stripe ST1 in the first HDD 21a will be updated with a new data segment D21. Similarly, the symbol “N2” affixed to data segment D22 indicates that another storage space of stripe ST1 in the second HDD 21b will be updated with this new data segment D22. The symbol “N3” affixed to data segment D23 indicates that still another storage space of stripe ST1 in the third HDD 21c will be updated with this new data segment D23. That is, the data segments D11, D12, and D13 in FIG. 3 constitute target data. On the other hand, the symbol “NP,” as in “NP1” in the box of parity data P21, represents new parity data produced from data segments D21, D22, and D23. This symbol “NP” is followed by a numeral “1” representing a specific storage space of parity data P11 for stripe ST1 in the HDDs 21a to 21d.

According to the bandwidth-write scheme, the controller module 10a overwrites relevant storage spaces of stripe ST1 in the four HDDs 21a to 21d with the produced data segments D21, D22, and D23 and parity data P21. Specifically, one storage space of stripe ST1 in the first HDD 21a is overwritten with data segment D21. Another storage space of stripe ST1 in the second HDD 21b is overwritten with data segment D22. Yet another storage space of stripe ST1 in the third HDD 21c is overwritten with data segment D23. Still another storage space of stripe ST1 in the fourth HDD 21d is overwritten with parity data P21. The data in stripe ST1 is thus updated as a result of the above overwrite operations.

The cache memory 104 may have an existing entry of data segments D11 to D13. When that is the case, the controller module 10a also updates the cached data segments D11 to D13 with new data segments D21 to D23, respectively, after the above-described update of stripe ST1 is finished.

(b2) Read & Bandwidth Write Scheme

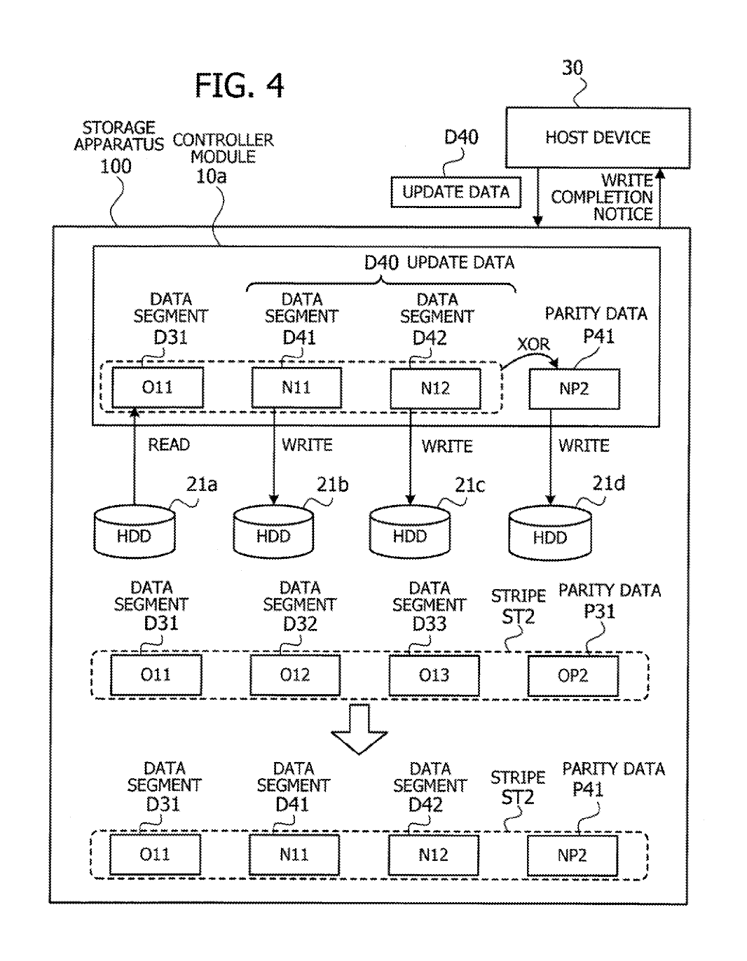

FIG. 4 illustrates a read & bandwidth-write scheme. As can be seen in FIG. 4, a stripe ST2 is formed from storage spaces distributed across four different HDDs 21a to 21d. This stripe ST2 contains three data segments D31, D32, and D33, together with parity data P31 produced from the data segments D31, D32, and D33 for ensuring their redundancy. In FIG. 4, the symbol “O11” affixed to data segment D31 indicates that a piece of old data resides in a storage space of stripe ST2 in the first HDD 21a. The symbol “O12” affixed to data segment D32 indicates that another piece of old data resides in another storage space of stripe ST2 in the second HDD 21b. Similarly, the symbol “O13” affixed to data segment D33 indicates that yet another piece of old data resides in yet another storage space of stripe ST2 in the third HDD 21c. The symbol “OP2” affixed to parity data P31 indicates that a piece of old parity data resides in still another storage space of stripe ST1 in the fourth HDD 21d.

Upon receipt of a write request of update data D40 from the host device 30, the controller module 10a produces new data segments D41 and D42 from the received update data D40. In FIG. 4, the symbol “N11” affixed to data segment D41 indicates that a relevant storage space of stripe ST2 in the second HDD 21b will be updated with this new data segment D41. Similarly, the symbol “N12” affixed to data segment D42 indicates that another storage space of stripe ST2 in the third HDD 21c will be updated with this new data segment D42. That is, data segments D32 and D33 constitute target data in the case of FIG. 4. Since data segment D31 is not part of the target data, the controller module 10a retrieves data segment D31 from its storage space of stripe ST2 in the HDDs 21a to 21d. The controller module 10a then calculates XOR of the produced data segments D41 and D42 and the retrieved data segment D31 to produce parity data P41 for ensuring their redundancy.

The controller module 10a overwrites each relevant storage space of stripe ST2 in the HDDs 21a to 21d with the produced data segments D41 and D42 and parity data P41. Specifically, one storage space of stripe ST2 in the second HDD 21b is overwritten with data segment D41. Another storage space of stripe ST2 in the third HDD 21c is overwritten with data segment D42. Yet another storage space of stripe ST2 in the fourth HDD 21d is overwritten with parity data P41. The data in stripe ST2 is thus updated as a result of the above overwrite operations.

The cache memory 104 may have an existing entry of data segments D32 and D33. When that is the case, the controller module 10a also updates the cached data segments D32 and D33 with new data segments D41 and D42, respectively, after the above-described update of stripe ST2 is finished.

(b3) First Small-Write Scheme

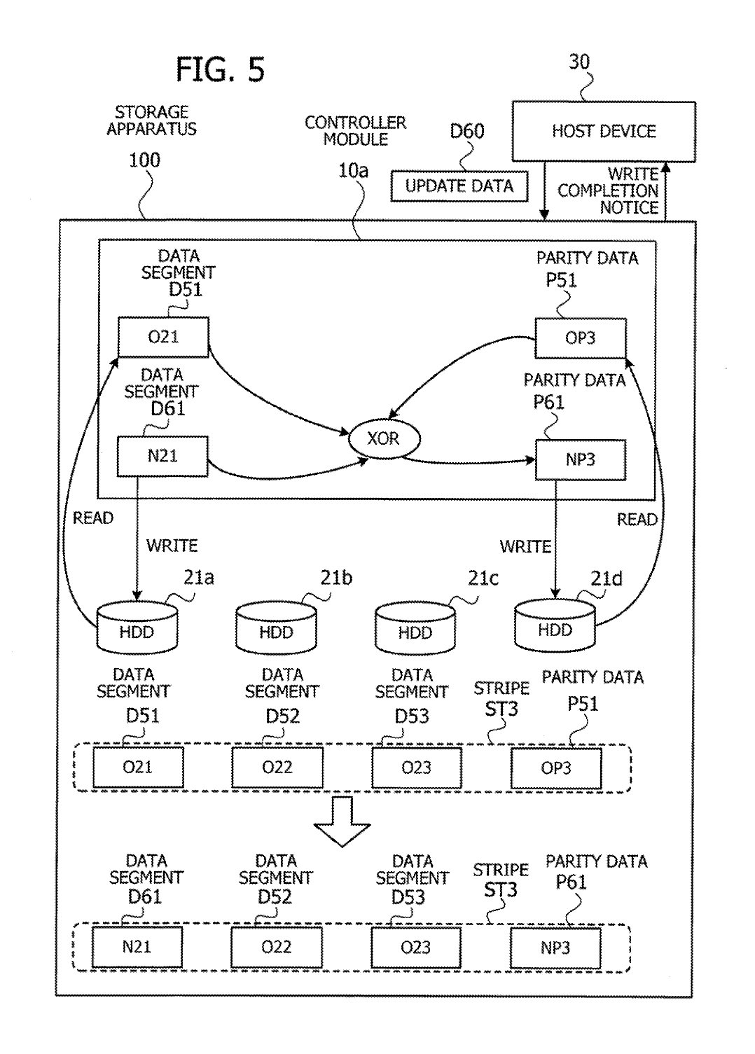

FIG. 5 illustrates a first small-write scheme. As can be seen in FIG. 5, a stripe ST3 is formed from storage spaces distributed across four different HDDs 21a to 21d. This stripe ST3 contains three data segments D51, D52, and D53, together with parity data P51 for ensuring redundancy of the data segments D51, D52, and D53. The symbol “O21” affixed to data segment D51 indicates that a piece of old data resides in a storage space of stripe ST3 in the first HDD 21a. The symbol “O22” affixed to data segment D52 indicates that another piece of old data resides in another storage space of stripe ST3 in the second HDD 21b. The symbol “O23” affixed to data segment D53 indicates that yet another piece of old data resides in yet another storage space of stripe ST3 in the third HDD 21c. Data segment D51 constitutes target data in the case of FIG. 5. The symbol “OP3” affixed to parity data P51 indicates that a piece of old parity data resides in still another storage space of stripe ST3 in the fourth HDD 21d.

Upon receipt of a write request of update data D60 from the host device 30, the controller module 10a produces a data segment D61 from the received update data D60. The symbol “N21” affixed to data segment D61 indicates that one storage space of stripe ST3 in the first HDD 21a will be updated with this new data segment D61. The controller module 10a retrieves data segment D51 and parity data P51 corresponding to the produced data segment D61 from their respective storage spaces of stripe ST3 in the first and fourth HDDs 21a and 21d. The controller module 10a then calculates XOR of the produced data segment D61 and the retrieve data segment D51 and parity data P51 to produce new parity data P61 for ensuring redundancy of data segments D61, D52, and D53.

The controller module 10a overwrites each relevant storage space of stripe ST3 in the HDDs 21a to 21d with the produced data segment D61 and parity data P61. Specifically, one storage space of stripe ST3 in the first HDD 21a is overwritten with data segment D61. Another storage space of stripe ST3 in the fourth HDD 21d is overwritten with parity data P61. The data in stripe ST3 is thus updated as a result of the above overwrite operations.

The cache memory 104 may have an existing entry of data segment D51. When that is the case, the controller module 10a also updates the cached data segment D51 with the new data segment D61, after the above-described update of stripe ST3 is finished.

(b4) Second Small-Write Scheme

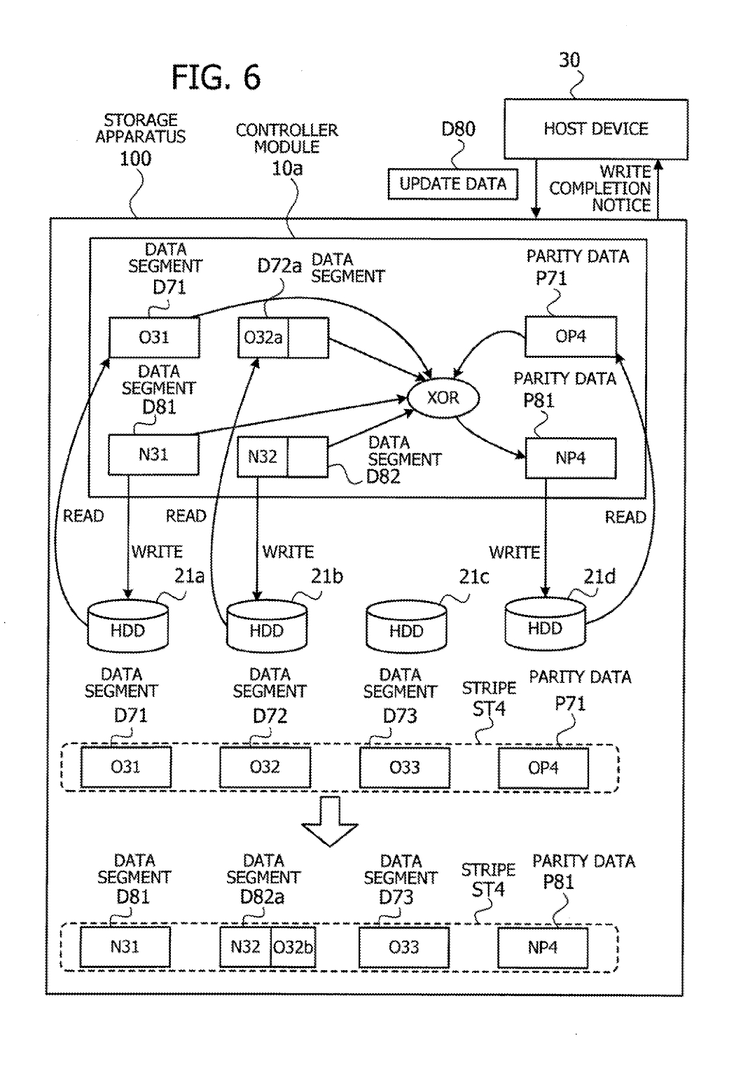

FIG. 6 illustrates a second small-write scheme. As can be seen in FIG. 6, a stripe ST4 is formed from storage spaces distributed across four different HDDs 21a to 21d. This stripe ST4 contains three data segments D71, D72, and D73, together with parity data P71 for ensuring redundancy of the data segments D71, D72, and D73. In FIG. 6, the symbol “O31” affixed to data segment D71 indicates that a piece of old data resides in a storage space of stripe ST4 in the first HDD 21a. The symbol “O32” affixed to data segment D72 indicates that another piece of old data resides in another storage space of stripe ST4 in the second HDD 21b. The symbol “O33” affixed to data segment D73 indicates that yet another piece of old data resides in yet another storage space of stripe ST4 in the third HDD 21c. The symbol “OP4” affixed to parity data P71 indicates that a piece of old parity data resides in still another storage space of stripe ST4 in the fourth HDD 21d.

Upon receipt of a write request of update data D80 from the host device 30, the controller module 10a produces data segments D81 and D82 from the received update data D80. The symbol “N31” affixed to data segment D81 indicates that one storage space of stripe ST4 in the first HDD 21a will be updated with this new data segment D81. The symbol “N32” affixed to data segment D82 indicates that another storage space of stripe ST4 in the second HDD 21b will be updated with a part of this new data segment D82. The remaining part of this data segment D82 contains zeros. That is, the whole data segment D71 and a part of data segment D72 constitute target data in the case of FIG. 6. The controller module 10a retrieves data segments D71 and D72a corresponding to the produced data segments D81 and D82, as well as parity data P71, from their respective storage spaces of stripe ST4 in the first, second, and fourth HDDs 21a, 21b, and 21d. Here, data segment D72a represents what is stored in the storage space for which new data segment D82 is destined. The controller module 10a then calculates XOR of the produced data segments D81 and D82 and the retrieved data segments D71 and D72a and parity data P71, thereby producing new parity data P81 for ensuring redundancy of the data segments D81, D82a, D73. Here, the data segment D82a is an updated version of data segment D72, a part of which has been replaced with the new data segment D82.

The controller module 10a overwrites each relevant storage space of stripe ST4 in the HDDs 21a to 21d with data segments D81 and D82 and parity data P81. Specifically, one storage space of stripe ST4 in the first HDD 21a is overwritten with data segment D81. Another storage space of stripe ST4 in the second HDD 21b is overwritten with data segment D82. This storage space is where an old data segment D72a has previously been stored. Referring to the bottom portion of FIG. 6, the symbol “O32b” is placed in an old data portion of data segment D82a which has not been affected by the overwriting of data segment D82. Yet another storage space of stripe ST4 in the fourth HDD 21d is overwritten with parity data P81. The data in stripe ST4 is thus updated as a result of the above overwrite operations.

The cache memory 104 may have an existing entry of data segments D71 and D72a. When that is the case, the controller module 10a also updates the cached data segments D71 and D72a with new data segments D81 and D82, respectively, after the above-described update of stripe ST4 is finished.

The next section will describe several functions provided in the controller modules 10a and 10b. The description focuses on the former controller module 10a since the two controller modules 10a and 10b are identical in their functions.

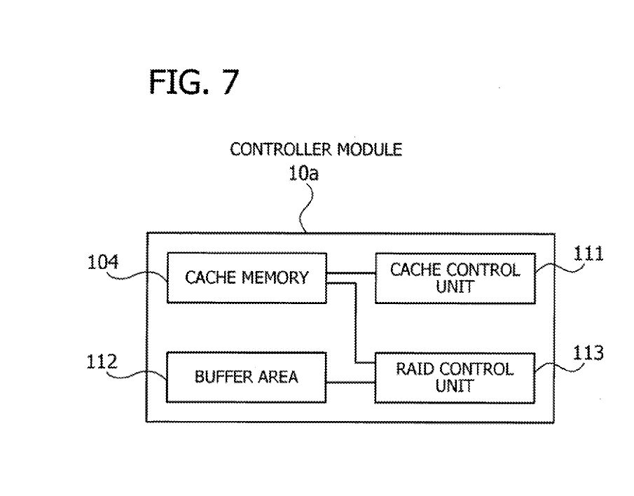

FIG. 7 is a functional block diagram of a controller module according to the second embodiment. The illustrated controller module 10a includes a cache memory 104, a cache control unit 111, a buffer area 112, and a RAID control unit 113. The cache control unit 111 and RAID control unit 113 may be implemented as functions executed by a processor such as the CPU 101 (FIG. 2). The buffer area 112 may be defined as a part of storage space of the RAM 102. The cache control unit 111 is an example implementation of the foregoing reception unit 3b and write control unit 3c. The RAID control unit 113 is an example implementation of the foregoing write control unit 3c.

The cache control unit 111 receives update data and puts the received update data in the cache memory 104. The cache control unit 111 analyzes this update data in the cache memory 104. When the analysis result indicates that an ordinary write-back method is specified for the received update data, the cache control unit 111 requests the RAID control unit 113 to use an ordinary write-back method for write operation of the update data.

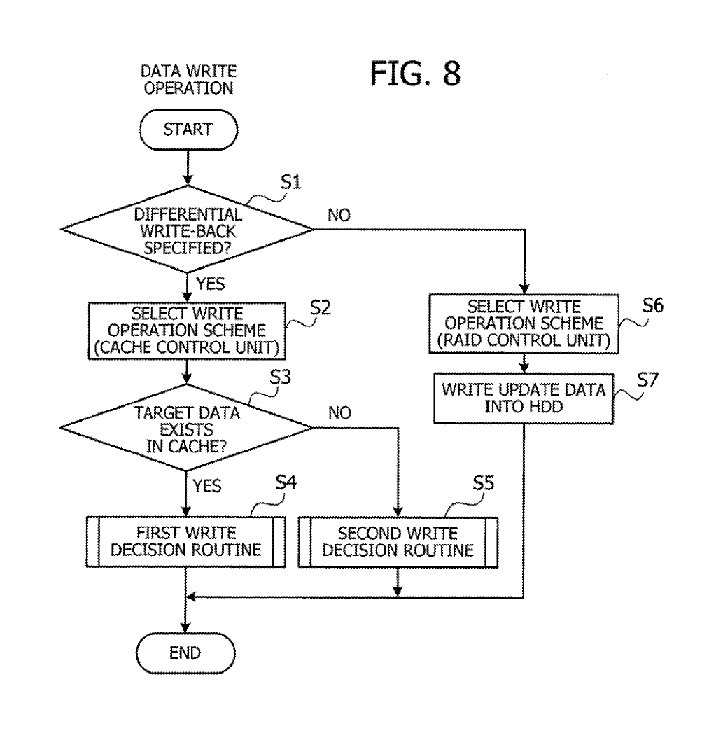

When the analysis result indicates that a differential write-back method is specified for the received update data, the cache control unit 111 tests whether the cache memory 104 has an existing entry of target data corresponding to the update data. When it is found that the target data is cached in the cache memory 104, the cache control unit 111 determines whether the target data in the cache memory 104 coincides with the update data. To make this determination, the cache control unit 111 produces comparison data for comparison between the target data and update data. This comparison data may vary depending on which of the foregoing three write operation schemes is used. Details of the comparison data will be explained later by way of example, with reference to the flowchart of FIG. 8.

Using the produced comparison data, the cache control unit 111 determines whether the target data coincides with the update data. When the target data is found to coincide with the update data, the cache control unit 111 determines not to write the update data to HDDs 21a to 21d and sends a write completion notice back to the requesting host device 30 to indicate that the update data has successfully been written in the HDD arrays 20. When, on the other hand, the target data stored in the cache memory 104 is found to be different from the specified update data, the cache control unit 111 executes a write operation of the update data to relevant storage spaces constituting the target stripe in the HDDs 21a to 21d by using one of the foregoing three write operation schemes. Upon successful completion of this write operation, the cache control unit 111 sends a write completion notice back to the requesting host device 30 to indicate that the update data has successfully been written in the HDD arrays 20.

The buffer area 112 serves as temporary storage of data read out of HDDs 21a to 21d by the RAID control unit 113.

The RAID control unit 113 may receive a notification from the cache control unit 111 which indicates reception of a write request of update data. In the case where the write request specifies an ordinary write-back method, the RAID control unit 113 reads out the update data from the cache memory 104 and writes it to relevant HDDs 21a to 21d when they are not busy.

In the case where the write request specifies a differential write-back method, the RAID control unit 113 executes it as follows. The RAID control unit 113 determines whether the update data coincides with its corresponding target data stored in relevant storage spaces constituting the target stripe in the HDDs 21a to 21d. For this purpose, the RAID control unit 113 retrieves comparison data from all or some of those storage spaces of the target stripe. Which storage spaces to read as comparison data may vary depending on which of the foregoing three write operation schemes is used. Details of the comparison data will be explained later by way of example, with reference to the flowchart of FIG. 8. The RAID control unit 113 keeps the retrieved comparison data in the buffer area 112.

Using the comparison data, the RAID control unit 113 determines whether the update data coincides with its corresponding target data stored in relevant storage spaces constituting the target stripe in the HDDs 21a to 21d. When the update data is found to coincide with the target data, the RAID control unit 113 determines not to write the update data to the HDDs 21a to 21d. The RAID control unit 113 sends a write completion notice back to the requesting host device 30 to indicate that the update data has successfully been written in the HDD arrays 20.

When, on the other hand, the update data is found to be different from the target data, the RAID control unit 113 executes a write operation of the update data to relevant storage spaces constituting the target stripe in the HDDs 21a to 21d by using one of the foregoing three write operation schemes. Upon successful completion of this write operation, the RAID control unit 113 sends a write completion notice back to the requesting host device 30 to indicate that the update data has successfully been written in the HDD arrays 20.

The above data write operations by the controller module 10a will now be described with reference to a flowchart. FIG. 8 is a flowchart illustrating data write operations performed by the controller module 10a. The controller module 10a executes the following steps of FIG. 8 each time a write request of specific update data is received from the host device 30. The process illustrated in FIG. 8 is described below in the order of step numbers:

(Step S1) In response to a write request of update data from the host device 30 to the controller module 10a, the cache control unit 111 determines whether the write request specifies a differential write-back method for the update data. The cache control unit 111 proceeds to step S2 if the write request specifies a differential write-back method (Yes at step S1). If not (No at step S1), then the cache control unit 111 branches to step S6.

(Step S2) The cache control unit 111 analyzes the update data and produces data segments therefrom. Based on the analysis result of update data, the cache control unit 111 selects which of the three write operation schemes to use. The write operation scheme selected at this step S2 will be used later at step S4 (first write decision routine) or step S5 (second write decision routine). Upon completion of this selection of write operation schemes, the cache control unit 111 advances to step S3.

(Step S3) The cache control unit 111 determines whether the cache memory 104 contains target data corresponding to the update data. When target data exists in the cache memory 104 (Yes at step S3), the cache control unit 111 advances to step S4. When target data is not found in the cache memory 104 (No at step S3), the cache control unit 111 proceeds to step S5.

(Step S4) The cache control unit 111 executes a first write decision routine when the determination at step S3 finds the presence of relevant target data in the cache memory 104. In this first write decision routine, the cache control unit 111 determines whether the update data coincides with the target data found in the cache memory 104 and, if it does, determines not to execute a write operation of the update data to HDDs 21a to 21d. As will be described in detail later, the comparison data used in this step S4 are prepared in different ways depending on which of the foregoing three write operation schemes is used. The cache control unit 111 terminates the process of FIG. 8 upon completion of the first write decision routine.

(Step S5) The RAID control unit 113 executes a second write decision routine when the cache control unit 111 has determined at step S3 that there is no relevant target data in the cache memory 104. In this second write decision routine, the RAID control unit 113 determines whether the update data coincides with target data in relevant storage spaces constituting the target stripe in HDDs 21a to 21d. When the update data coincides with the target data, the RAID control unit 113 determines not to execute a write operation of the update data to the HDDs 21a to 21d. As will be described in detail later, the comparison data used in this step S5 are prepared in different ways depending on which of the foregoing three write operation schemes is used. The RAID control unit 113 terminates the process of FIG. 8 upon completion of the second write decision routine.

(Step S6) The RAID control unit 113 analyzes the given update data. Based on the analysis result, the RAID control unit 113 selects which of the three write operation schemes to use.

(Step S7) The RAID control unit 113 executes a write operation according to an ordinary write-back method. Specifically, the RAID control unit 113 writes the update data received from the host device 30 into each relevant storage space constituting the target stripe in HDDs 21a to 21d by using the write operation scheme selected at step S6. Upon successful completion of this write operation, the RAID control unit 113 sends a write completion notice back to the requesting host device 30 to indicate that the update data has successfully been written in the HDD arrays 20, thus terminating the process of FIG. 8.

The data write operation of FIG. 8 has been described above. As can be seen from the explained process of FIG. 8, the controller module 10a is designed to detect at step S1 update data that is supposed to be written back in a differential manner, and to execute subsequent steps S3 to S5 only for such update data. The determination made at step S1 for differential write-back reduces the processing load on the controller module 10a since it is not necessary to subject every piece of received update data to steps S3 to S5.

The aforementioned first write decision routine of step S4 will now be described in detail below. As noted above, the first write decision routine prepares different comparison data depending on which of the three write operation schemes is selected by the cache control unit 111 at step S2. The following explanation begins with an assumption that the cache control unit 111 selects a bandwidth-write scheme at step S2.

(b5) First Write Decision Routine Using Bandwidth-Write Scheme

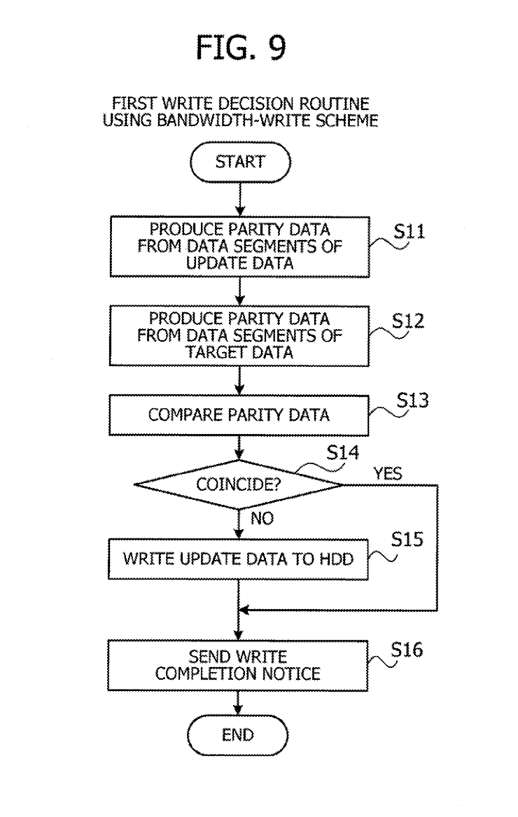

FIG. 9 is a flowchart illustrating a first write decision in the bandwidth-write scheme. Each step of FIG. 9 is described below in the order of step numbers:

(Step S11) The cache control unit 111 calculates XOR of data segments produced from given update data, thereby producing parity data for ensuring redundancy of those data segments. The cache control unit 111 proceeds to step S12, keeping the produced parity data in the cache memory 104.

(Step S12) The cache control unit 111 calculates XOR of existing data segments of the target data cached in the cache memory 104, thereby producing parity data for ensuring their redundancy. The cache control unit 111 proceeds to step S13, keeping the produced parity data in the cache memory 104.

(Step S13) The cache control unit 111 compares the parity data produced at step S11 with that produced at step S12 and proceeds to step S14.

(Step S14) With the comparison result of step S13, the cache control unit 111 determines whether the parity data produced at step S11 coincides with that produced at step S12. If those two pieces parity data coincide with each other (Yes at step S14), the cache control unit 111 skips to step S16. If the two pieces parity data does not coincide (No at step S14), the cache control unit 111 moves on to step S15.

(Step S15) The cache control unit 111 writes data segments produced from the update data, together with their corresponding parity data produced at step S12, into relevant storage spaces constituting the target stripe in the HDDs 21a to 21d by using a bandwidth-write scheme. Upon completion of this write operation, the cache control unit 111 advances to step S16.

(Step S16) The cache control unit 111 sends a write completion notice back to the requesting host device 30 to indicate that the update data has successfully been written in the HDD arrays 20. The cache control unit 111 exists from the first write decision routine.

The first write decision routine of FIG. 9 has been described above. It is noted, however, that the embodiment is not limited by the specific execution order described above for steps S11 and S12. That is, the cache control unit 111 may execute step S12 before step S11. More specifically, the cache control unit 111 may first calculate XOR of existing data segments of the target data cached in the cache memory 104 and store the resulting parity data in the cache memory 104. The cache control unit 111 produces another piece of parity data from the update data, overwrites the existing data segments of the target data in the cache memory 104 with data segments newly produced from the update data, and then compares two pieces of parity data. This execution order of steps may reduce cache memory consumption in the processing described in FIG. 9.

As can be seen from FIG. 9, the cache control unit 111 is configured to return a write completion notice to the host device 30 without writing data to HDDs 21a to 21d when a coincidence is found in the data comparison at step S14. This is because the coincidence found at step S14 means that the data stored in relevant storage spaces of the target stripe in HDDs 21a to 21d is identical to the update data, and thus no change is necessary. The next section will describe what is performed in the first write decision routine in the case where the cache control unit 111 has selected a read & bandwidth-write scheme at step S2 of FIG. 8.

(b6) First Write Decision Routine Using Read & Bandwidth-Write Scheme

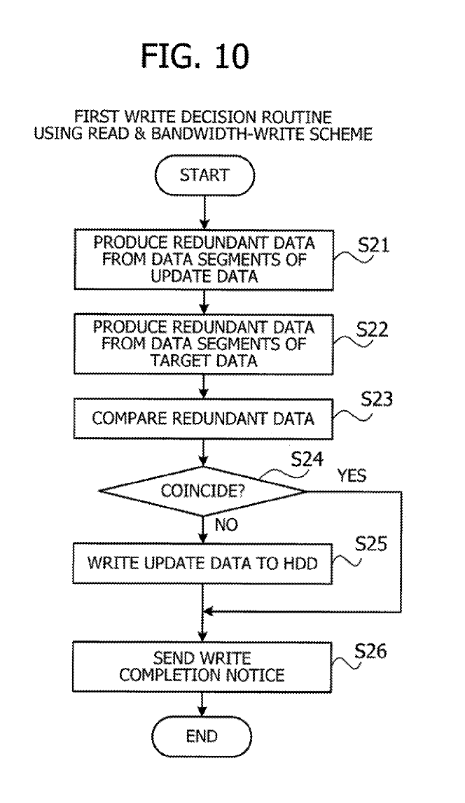

FIG. 10 is a flowchart illustrating a first write decision routine using a read & bandwidth-write scheme. Each step of FIG. 10 is described below in the order of step numbers:

(Step S21) The cache control unit 111 calculates XOR of data segments produced from given update data, thereby producing parity data for ensuring redundancy of those data segments. Similarly to parity data, redundant data is produced from a plurality of data segments to ensure their redundancy. Unlike parity data, however, the redundant data may not be capable of reconstructing HDD data in case of failure of HDDs 21a to 21d. The rest of the description distinguishes the two terms “parity data” and “redundant data” in that sense. The cache control unit 111 proceeds to step S22, keeping the produced redundant data in the cache memory 104.

(Step S22) The cache control unit 111 calculates XOR of existing data segments of the target data cached in the cache memory 104, thereby producing redundant data for ensuring their redundancy. The cache control unit 111 proceeds to step S23, keeping the produced redundant data in the cache memory 104.

(Step S23) The cache control unit 111 compares the redundant data produced at step S21 with that produced at step S22 and advances to step S24.

(Step S24) With the comparison result of step S23, the cache control unit 111 determines whether the redundant data produced at step S21 coincides with that produced at step S22. If those two pieces of redundant data coincide with each other (Yes at step S24), the cache control unit 111 skips to step S26. If any difference is found in the two pieces of redundant data (No at step S24), the cache control unit 111 moves on to step S25.

(Step S25) The cache control unit 111 writes data segments produced from the update data, together with their corresponding redundant data produced at step S22, into relevant storage spaces constituting the target stripe in the HDDs 21a to 21d by using a read & bandwidth-write scheme. Upon completion of this write operation, the cache control unit 111 advances to step S26.

(Step S26) The cache control unit 111 sends a write completion notice back to the requesting host device 30 to indicate that the update data has successfully been written in the HDD arrays 20. The cache control unit 111 then exists from the first write decision routine.

The first write decision routine of FIG. 10 has been described above. It is noted, however, that the embodiment is not limited by the specific execution order described above for steps S21 and S22. That is, the cache control unit 111 may execute step S22 before step S21. More specifically, the cache control unit 111 may first calculate XOR of existing data segments of the target data cached in the cache memory 104 and store the resulting redundant data in the cache memory 104. The cache control unit 111 produces another piece of redundant data from the update data, overwrites the existing data segments of the target data in the cache memory 104 with data segments newly produced from the update data, and then compares the two pieces of redundant data. This execution order of steps may reduce cache memory consumption in the processing described in FIG. 10.

As can be seen from FIG. 10, the cache control unit 111 is configured to return a write completion notice to the host device 30 without writing data to HDDs 21a to 21d when a coincidence is found in the data comparison at step S24. This is because the coincidence at step S24 means that the data stored in relevant storage spaces of the target stripe in HDDs 21a to 21d is identical to the update data. The next section (b7) will describe what is performed in the first write decision routine in the case where the cache control unit 111 has selected a first small-write scheme at step S2 of FIG. 8.

(b7) First Write Decision Routine Using First Small-Write Scheme

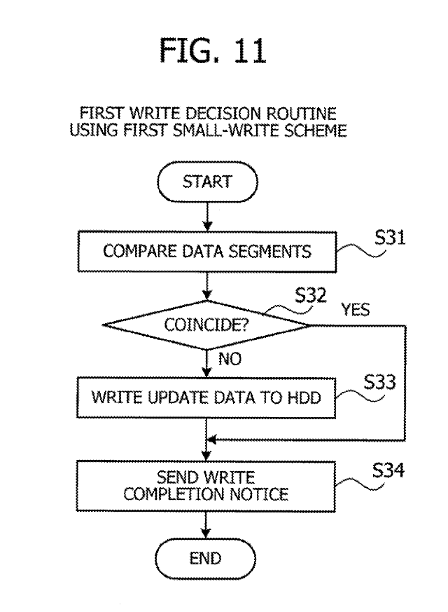

FIG. 11 is a flowchart illustrating a first write decision routine using a first small-write scheme. Each step of FIG. 11 is described below in the order of step numbers:

(Step S31) The cache control unit 111 compares data segments produced from given update data with existing data segments of its corresponding target data cached in the cache memory 104. The cache control unit 111 then advances to step S32.

(Step S32) With the comparison result of step S32, the cache control unit 111 determines whether the data segments produced from the update data coincides with those of the target data cached in the cache memory 104. The cache control unit 111 skips to step S34 if those two sets of data segments coincide with each other (Yes at step S32). If any difference is found in the two sets of data segments (No at step S32), the cache control unit 111 moves on to step S33.

(Step S33) The cache control unit 111 writes the data segments produced from the update data into relevant storage spaces constituting the target stripe in HDDs 21a to 21d by using a first small-write scheme. Upon completion of this write operation, the cache control unit 111 advances to step S34.

(Step S34) The cache control unit 111 sends a write completion notice back to the requesting host device 30 to indicate that the update data has successfully been written in the HDD arrays 20. The cache control unit 111 then exists from the first write decision routine.

The first write decision routine of FIG. 11 has been described above. The next section (b8) will describe what is performed in the first write decision routine in the case where the cache control unit 111 has selected a second small-write scheme at step S2 of FIG. 8.

(b8) Second Write Decision Routine Using Second Small-Write Scheme

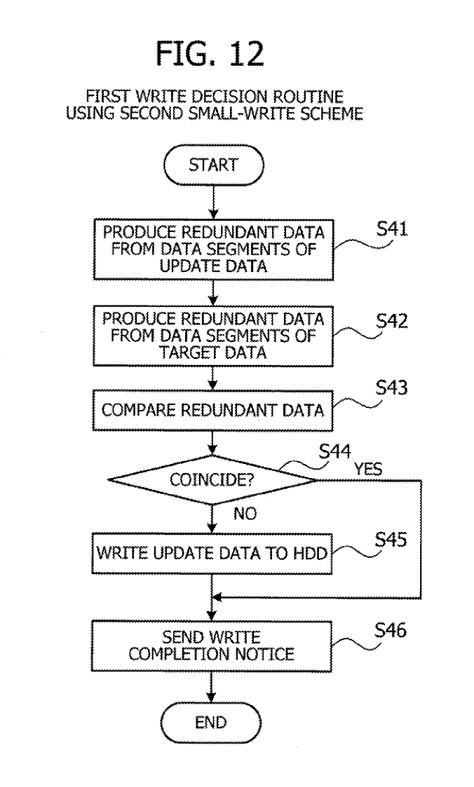

FIG. 12 is a flowchart illustrating a first write decision routine using a second small-write scheme. Each step of FIG. 12 is described below in the order of step numbers:

(Step S41) The cache control unit 111 calculates XOR of data segments produced from given update data, thereby producing redundant data for ensuring their redundancy. Some data segments may contain update data only in part of their respective storage spaces. For such data segments, the cache control unit 111 performs zero padding (i.e., enters null data) to the remaining part of their storage spaces when executing the above XOR operation. The cache control unit 111 proceeds to step S42, keeping the produced redundant data in the cache memory 104.

(Step S42) The cache control unit 111 calculates XOR of existing data segments of the target data cached in the cache memory 104, thereby producing redundant data for ensuring their redundancy. The cache control unit 111 proceeds to step S43, keeping the produced redundant data in the cache memory 104.

(Step S43) The cache control unit 111 compares the redundant data produced at step S41 with that produced at step S42 and advances to step S44.

(Step S44) With the comparison result of step S43, the cache control unit 111 determines whether the redundant data produced at step S41 coincides with that produced at step S42. If those two pieces of redundant data coincide with each other (Yes at step S44), the cache control unit 111 skips to step S46. If any difference is found in those two pieces of redundant data (No at step S44), the cache control unit 111 moves on to step S45.

(Step S45) The cache control unit 111 writes the data segments produced from the update data into relevant storage spaces constituting the target stripe in HDDs 21a to 21d by using a second small-write scheme. Upon completion of this write operation, the cache control unit 111 advances to step S46.

(Step S46) The cache control unit 111 sends a write completion notice back to the requesting host device 30 to indicate that the update data has successfully been written in the HDD arrays 20. The cache control unit 111 then exists from the first write decision routine.

The first write decision routine of FIG. 12 has been described above. It is noted, however, that the embodiment is not limited by the specific execution order described above for steps S41 and S42. That is, the cache control unit 111 may execute step S42 before step S41. More specifically, the cache control unit 111 may first calculate XOR of existing data segments of the target data cached in the cache memory 104 and store the resulting redundant data in the cache memory 104. The cache control unit 111 produces another piece of redundant data from the update data, overwrites the existing data segments of the target data in the cache memory 104 with data segments newly produced from the update data, and then compares the two pieces of redundant data. This execution order of steps may reduce cache memory consumption in the processing described in FIG. 12.

As can be seen from FIG. 12, the cache control unit 111 is configured to return a write completion notice to the host device 30 without writing data to HDDs 21a to 21d when a coincidence is found in the data comparison at step S44. This is because the coincidence at step S44 means that the data stored in relevant storage spaces of the target stripe in HDDs 21a to 21d is identical to the update data.

The aforementioned second write decision routine of step S5 in FIG. 8 will now be described in detail below. The following explanation begins with an assumption that the cache control unit 111 selects a bandwidth-write scheme at step S2.

The second write decision routine prepares different comparison data depending on which of the three write operation schemes has been selected by the controller module 10a, as will be seen from the following description.

(b9) Second Write Decision Routine Using Bandwidth-Write Scheme

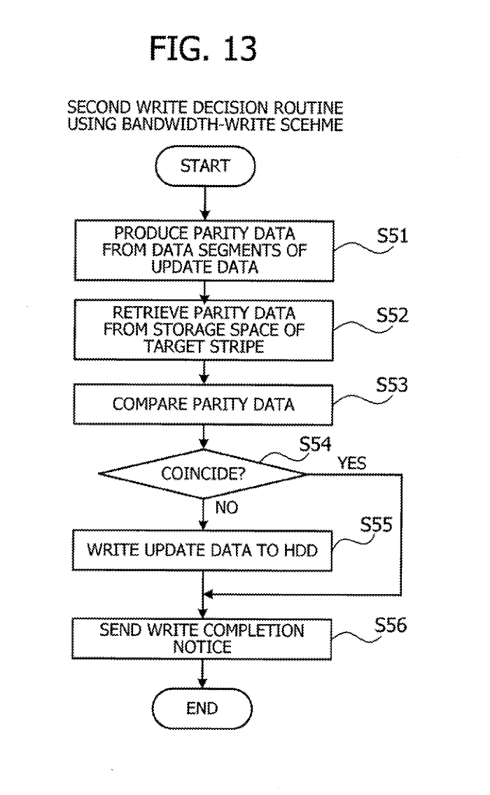

FIG. 13 is a flowchart illustrating a second write decision routine using a bandwidth-write scheme. Each step of FIG. 13 is described below in the order of step numbers:

(Step S51) The RAID control unit 113 calculates XOR of data segments that the cache control unit 111 has produced from given update data at step S2 of FIG. 8, thereby producing parity data for ensuring redundancy of those data segments. The RAID control unit 113 proceeds to step S52, keeping the produced parity data in the cache memory 104.

(Step S52) The RAID control unit 113 retrieves parity data from one of the storage spaces constituting the target stripe in HDDs 21a to 21d. The RAID control unit 113 then advances to step S53, keeping the retrieved parity data in the cache memory 104.

(Step S53) The RAID control unit 113 compares the parity data produced at step S51 with the parity data retrieved at step S52 and then proceeds to step S54.

(Step S54) With the comparison result of step S53, the RAID control unit 113 determines whether the parity data produced at step S53 coincides with that retrieved at step S52. The RAID control unit 113 skips to step S56 if these two pieces of parity data coincide with each other (Yes at step S54). If any difference is found between them (No at step S54), the RAID control unit 113 moves on to step S55.

(Step S55) The RAID control unit 113 writes data segments produced from the update data, together with their corresponding parity data produced at step S51, into relevant storage spaces constituting the target stripe in HDDs 21a to 21d by using a bandwidth-write scheme. Upon completion of this write operation, the RAID control unit 113 advances to step S56.

(Step S56) The RAID control unit 113 sends a write completion notice back to the requesting host device 30 to indicate that the update data has successfully been written in the HDD arrays 20. The RAID control unit 113 then exists from the second write decision routine.

The second write decision routine of FIG. 13 has been described above. It is noted, however, that the embodiment is not limited by the specific execution order described above for steps S51 and S52. That is, the RAID control unit 113 may execute step S52 before step S51.

As can be seen from FIG. 13, the RAID control unit 113 is configured to return a write completion notice to the host device 30 at step S56, without writing data to HDDs 21a to 21d, when a coincidence is found in the comparison between parity data produced step S51 and parity data retrieved at step S51. This is because the coincidence at step S54 means that the data stored in relevant storage spaces of the target stripe in HDDs 21a to 21d is identical to the update data.

The next section will describe what is performed in the second write decision routine in the case where the cache control unit 111 has selected a read & bandwidth-write scheme at step S2 of FIG. 8.

(b10) Second Write Decision Routine Using the Read & Bandwidth-Write Scheme

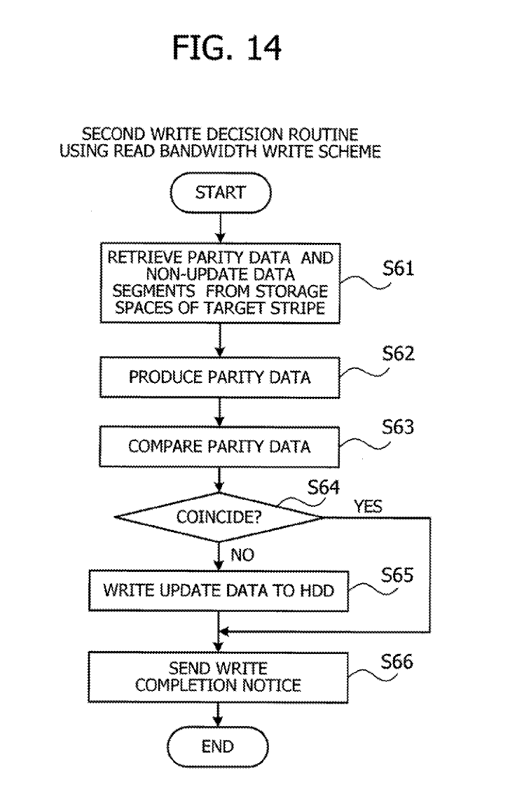

FIG. 14 is a flowchart illustrating a second write decision routine using a read & bandwidth-write scheme. Each step of FIG. 14 is described below in the order of step numbers:

(Step S61) Storage spaces constituting the target stripe in HDDs 21a to 21d include those to be affected by update data and those not to be affected by the same. The RAID control unit 113 retrieves data segments from the latter group of storage spaces. These data segments retrieved at step S61 may also be referred to as first data segments not to be updated. To distinguish between which data segments are to be changed and which are not, the RAID control unit 113 may use the result of an analysis that the cache control unit 111 has previously performed on the update data at step S2. Alternatively the RAID control unit 113 may analyze the update data by itself to distinguish the same. The retrieved data segment is kept in the cache memory 104. The RAID control unit 113 also retrieves parity data out of a relevant storage space of the target stripe in the HDDs 21a to 21d. The RAID control unit 113 stores the retrieved parity data in the buffer area 112 and proceeds to step S62.

(Step S62) The RAID control unit 113 calculates XOR of data segments of the update data and those retrieved at step S61, thereby producing parity data for ensuring their redundancy. The RAID control unit 113 proceeds to step S63, keeping the produced parity data in the cache memory 104.

(Step S63) The RAID control unit 113 compares the parity data produced at step S62 with that retrieved at step S61 and proceeds to step S64.

(Step S64) With the comparison result of step S63, the RAID control unit 113 determines whether the parity data produced at step S62 coincides with that retrieved at step S61. The RAID control unit 113 skips to step S64 if those two pieces of parity data coincide with each other (Yes at step S64). If any difference is found between them (No at step S64), the RAID control unit 113 moves on to step S65.

(Step S65) The RAID control unit 113 writes data segments produced from the update data, together with their corresponding parity data produced at step S62, into relevant storage spaces constituting the target stripe in HDDs 21a to 21d by using a read & bandwidth-write scheme. Upon completion of this write operation, the RAID control unit 113 advances to step S66.

(Step S66) The RAID control unit 113 sends a write completion notice back to the requesting host device 30 to indicate that the update data has successfully been written in the HDD arrays 20. The RAID control unit 113 then exists from the second write decision routine.

The second write decision routine of FIG. 14 has been described above. It is noted, however, that the embodiment is not limited by the specific execution order described above for steps S61 and S62. That is, the RAID control unit 113 may execute step S62 before step S61.

As can be seen from FIG. 14, the RAID control unit 113 is configured to return a write completion notice to the host device 30 without writing data to HDDs 21a to 21d when a coincidence is found in the data comparison at step S64. This is because the coincidence at step S64 means that the data stored in relevant storage spaces of the target stripe in HDDs 21a to 21d is identical to the update data. The next section (b11) will describe what is performed in the second write decision routine in the case where the cache control unit 111 has selected a first small-write scheme at step S2 of FIG. 8.

(b11) Second Write Decision Routine Using First Small-Write Scheme

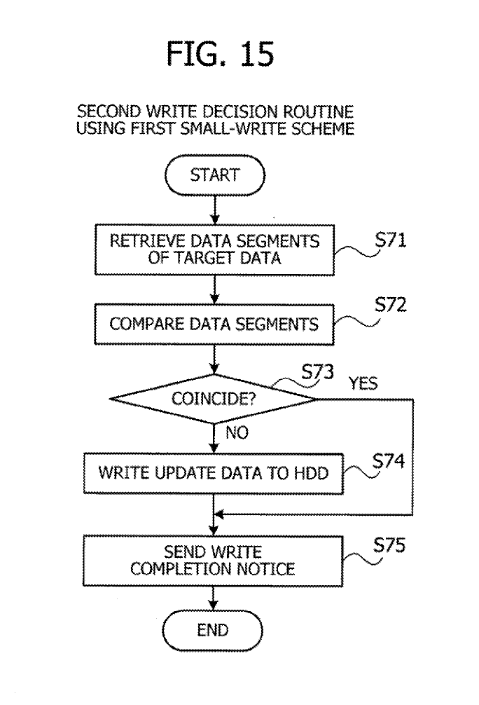

FIG. 15 is a flowchart illustrating a second write decision routine using a first small-write scheme. Each step of FIG. 15 is described below in the order of step numbers:

(Step S71) Storage spaces constituting the target stripe in the HDDs 21a to 21d include those to be affected by update data and those not to be affected by the same. The RAID control unit 113 retrieves data segments from the former group of storage spaces. The RAID control unit 113 stores the retrieved data segments in the buffer area 112 and proceeds to step S72.

(Step S72) The RAID control unit 113 compares the data segments produced from update data with those retrieved at step S71 and proceeds to step S73.

(Step S73) With the comparison result of step S72, the RAID control unit 113 determines whether the data segments produced from update data coincide with those retrieved at step S71. The RAID control unit 113 skips to step S75 if these two sets of data segments coincide with each other (Yes at step S73). If any difference is found between them (No at step S73), the RAID control unit 113 moves on to step S74.

(Step S74) The RAID control unit 113 writes the data segments produced from the update data into relevant storage spaces constituting the target stripe in HDDs 21a to 21d by using a first small-write scheme. Upon completion of this write operation, the RAID control unit 113 advances to step S75.

(Step S75) The RAID control unit 113 sends a write completion notice back to the requesting host device 30 to indicate that the update data has successfully been written in the HDD arrays 20. The RAID control unit 113 then exists from the second write decision routine.

The second write decision routine of FIG. 15 has been described above. The next section (b12) will describe what is performed in the second write decision routine in the case where the cache control unit 111 has selected a second small-write scheme at step S2 of FIG. 8.

(b12) Second Write Decision Routine Using Second Small-Write Scheme

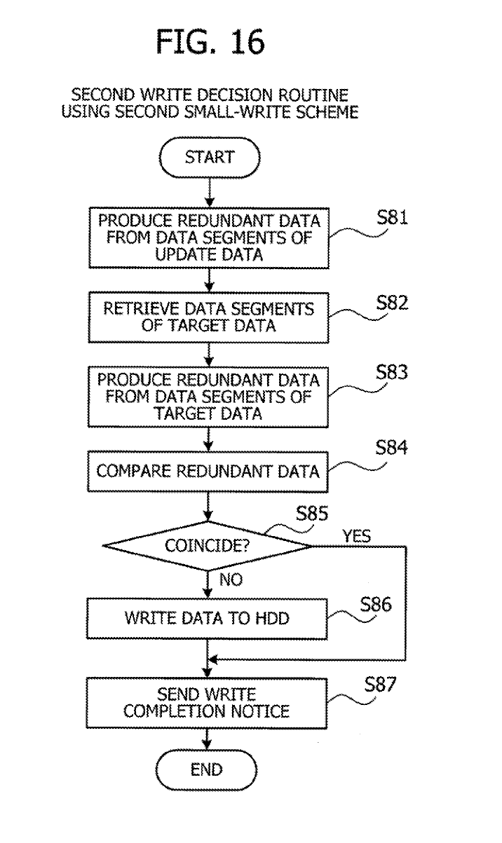

FIG. 16 is a flowchart illustrating a second write decision routine using a second small-write scheme. Each step of FIG. 16 is described below in the order of step numbers:

(Step S81) The RAID control unit 113 calculates XOR of data segments produced from given update data, thereby producing redundant data for ensuring their redundancy. Some data segments may contain update data only in part of their respective storage spaces. For such data segments, the RAID control unit 113 performs zero padding (i.e., enters null data) to the remaining part of their storage spaces when executing the above XOR operation. The RAID control unit 113 proceeds to step S82, keeping the produced redundant data in the cache memory 104.

(Step S82) Storage spaces constituting the target stripe in the HDDs 21a to 21d include those to be affected by update data and those not to be affected by the same. The RAID control unit 113 retrieves data segments from the former group of storage spaces. The RAID control unit 113 stores the retrieved data segments in the buffer area 112 and proceeds to step S83.

(Step S83) The RAID control unit 113 calculates XOR of the data segments retrieved at step S82, thereby producing redundant data for ensuring redundancy of those data segments constituting the target data. The RAID control unit 113 then proceeds to step S84.

(Step S84) The RAID control unit 113 compares the redundant data produced at step S81 with that produced at step S83 and then proceeds to step S85.

(Step S85) With the comparison result of step S84, the RAID control unit 113 determines whether the redundant data produced at step S81 coincides with that produced at step S83. The RAID control unit 113 skips to step S87 if those two pieces of redundant data coincide with each other (Yes at step S85). If they do not (No at step S85), the RAID control unit 113 moves on to step S86.

(Step S86) The RAID control unit 113 writes the data segments produced from the update data into relevant storage spaces constituting the target stripe in HDDs 21a to 21d by using the second small-write scheme. Upon completion of this write operation, the RAID control unit 113 advances to step S87.

(Step S87) The RAID control unit 113 sends a write completion notice back to the requesting host device 30 to indicate that the update data has successfully been written in the HDD arrays 20. The RAID control unit 113 then exists from the second write decision routine.

The second write decision routine of FIG. 16 has been described above. The following sections will now provide several specific examples of the first and second write decision routines with each different write operation scheme, assuming that the HDDs are organized as a RAID 5 (3+1) system.

(b13) Example of First Write Decision Routine Using Bandwidth-Write Scheme

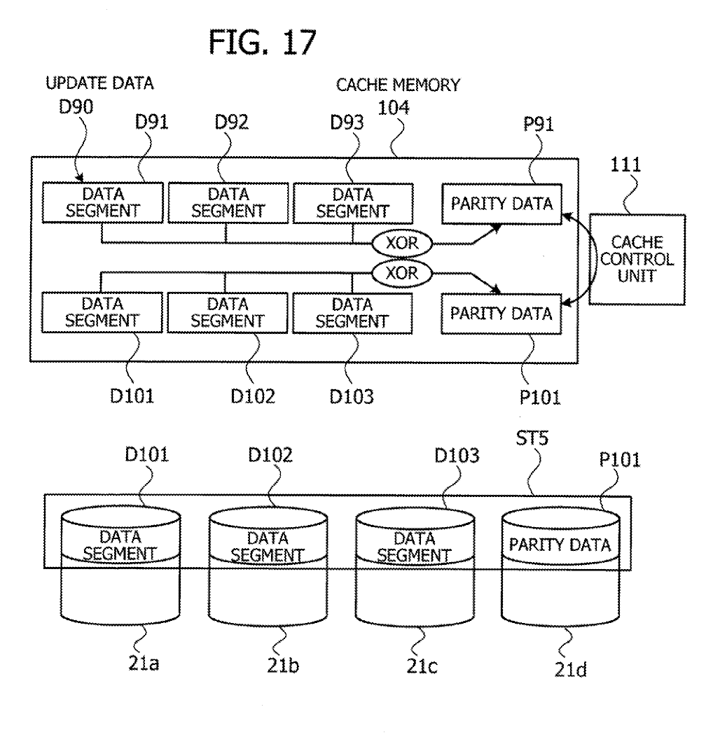

FIG. 17 illustrates a specific example of the first write decision routine using a bandwidth-write scheme. As seen in FIG. 17, a stripe ST5 is formed from storage spaces distributed across four different HDDs 21a to 21d. These storage spaces of stripe ST5 accommodate three data segments D101, D102, and D103, together with parity data P101 for ensuring their redundancy.

The cache memory 104, on the other hand, stores data segments D91, D92, and D93 produced by the cache control unit 111 from given update data D90 with a size of one stripe. The cache control unit 111 has also found that a differential write-back method is specified for that update data D90. The cache memory 104 also stores data segments D101, D102, and D103, which are target data corresponding to the data segments D91, D92, and D93. These data segments D101, D102, and D103 have been resident in the cache memory 104 and are available to the cache control unit 111 at the time of executing a first write decision routine.

The cache control unit 111 calculates XOR of data segments D91, D92, and D93 of the given update data, thereby producing parity data P91. The cache control unit 111 keeps the produced parity data P91 in the cache memory 104. The cache control unit 111 also calculates XOR of existing data segments D101, D102, and D103 in the cache memory 104, thereby producing another piece of parity data P101 for ensuring redundancy of those data segments. The cache control unit 111 keeps the produced parity data P101 in the cache memory 104. The cache control unit 111 then determines whether parity data P91 coincides with parity data P101. When those two pieces of parity data P91 and P101 coincide with each other, the cache control unit 111 determines not to write data segments D91, D92, and D93 to storage spaces of stripe ST5 in the HDDs 21a to 21d. When any difference is found between the two pieces of parity data P91 and P101, the cache control unit 111 writes data segments D91, D92, and D93, together with its corresponding parity data P91, to their relevant storage spaces of stripe ST5 in the HDDs 21a to 21d by using a bandwidth-write scheme. For details of the bandwidth-write scheme, see the foregoing description of FIG. 3.

(b14) Example of First Write Decision Routine Using Read & Bandwidth-Write Scheme

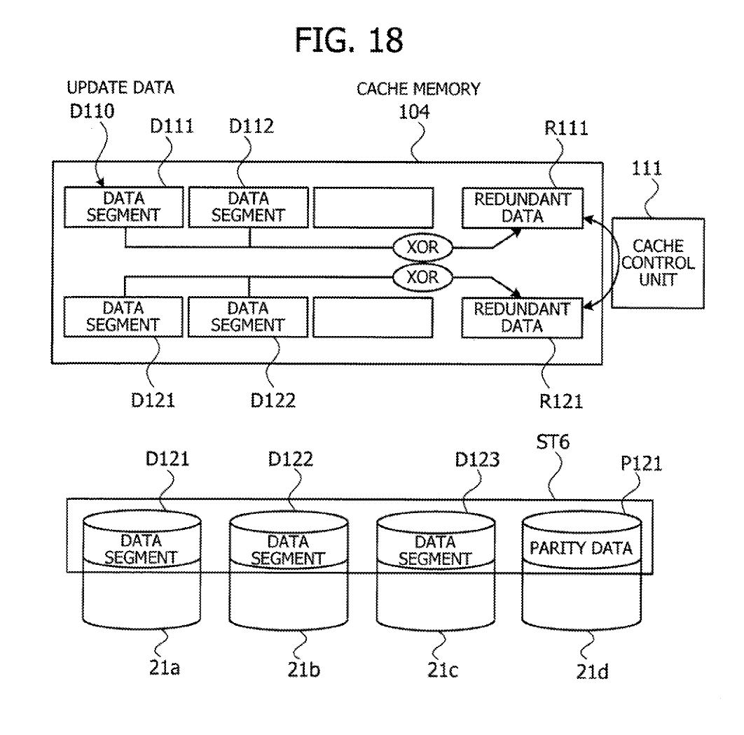

FIG. 18 illustrates a specific example of the first write decision routine using a read & bandwidth-write scheme. As seen in FIG. 18, a stripe ST6 is formed from storage spaces distributed across four different HDDs 21a to 21d. These storage spaces of stripe ST6 accommodate three data segments D121, D122, and D123, together with parity data P121 for ensuring their redundancy.

The cache memory 104, on the other hand, stores data segments D111 and D112. These data segments are what the cache control unit 111 has produced from given update data D110. The cache control unit 111 has also found that a differential write-back method is specified for that update data D110. The cache memory 104 also stores data segments D121 and D122, which are target data corresponding to the data segments D111 and D112. These data segments D121 and D122 have been resident in the cache memory 104 and are available to the cache control unit 111 at the time of executing a first write decision routine.

The cache control unit 111 calculates XOR of data segments D111 and D112 produced from the update data D110, thereby producing redundant data R111 for ensuring their redundancy. The cache control unit 111 keeps the produced redundant data R111 in the cache memory 104. The cache control unit 111 also calculates XOR of existing data segments D121 and D122 in the cache memory 104, thereby producing another piece of redundant data R121 for ensuring their redundancy. The cache control unit 111 keeps the produced redundant data R121 in the cache memory 104.

The cache control unit 111 then determines whether the former redundant data R111 coincides with the latter redundant data R121. When those two pieces of redundant data R111 and R121 coincide with each other, the cache control unit 111 determines not to write data segments D111 and D112 to storage spaces of stripe ST6 in HDDs 21a to 21d. When any difference is found between the two pieces of redundant data R111 and R121, the cache control unit 111 writes the data segments D111 and D112 to their relevant storage spaces of stripe ST6 in the HDDs 21a to 21d by using a read & bandwidth-write scheme. For details of the read & bandwidth-write scheme, see the foregoing description of FIG. 4.

(b15) Example of First Write Decision Routine Using First Small-Write Scheme

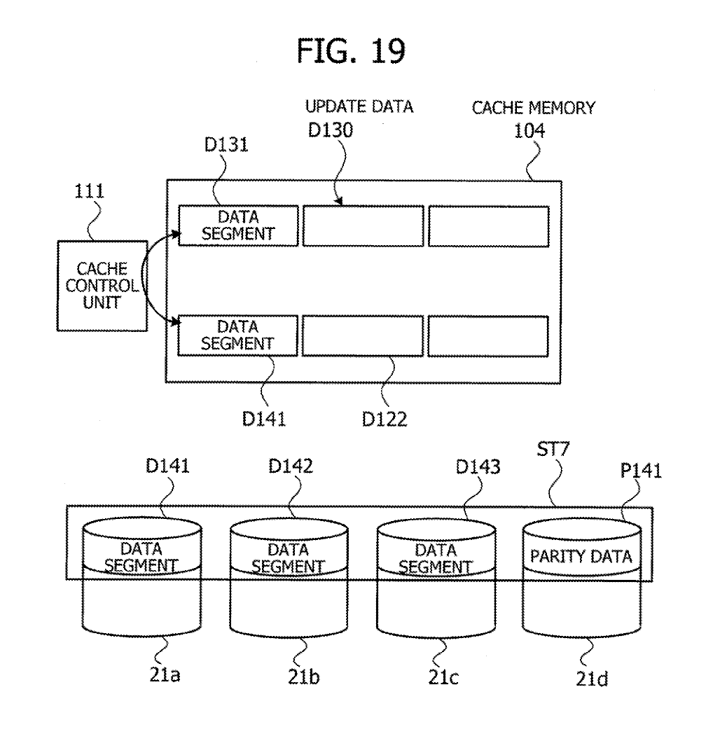

FIG. 19 illustrates a specific example of the first write decision routine using a first small-write scheme. As seen in FIG. 19, a stripe ST7 is formed from storage spaces distributed across four different HDDs 21a to 21d. These storage spaces of stripe ST7 accommodate three data segments D141, D142, and D143, together with parity data P141 for ensuring their redundancy.

The cache memory 104, on the other hand, stores a data segment D131. This data segment D131 has been produced by the cache control unit 111 from given update data D130. The cache control unit 111 has also found that a differential write-back method is specified for that update data D130. The cache memory 104 also stores a data segment D141, which is a part of target data corresponding to the data segment D131. This data segment D141 has been resident in the cache memory 104 and is available to the cache control unit 111 at the time of executing a first write decision routine.

The cache control unit 111 determines whether the data segment D131 produced from update data coincides with the existing data segment D141 in the cache memory 104. If those two data segments D131 and D141 coincide with each other, the cache control unit 111 determines not to write data segment D131 to storage spaces of stripe ST7 in HDDs 21a to 21d. If any difference is found between the two data segments D131 and D141, the cache control unit 111 writes the data segment D131 into a relevant storage space of stripe ST7 in the HDDs 21a to 21d by using a first small-write scheme. For details of the first small-write scheme, see the foregoing description of FIG. 5.

(b16) Example of First Write Decision Routine Using Second Small-Write Scheme

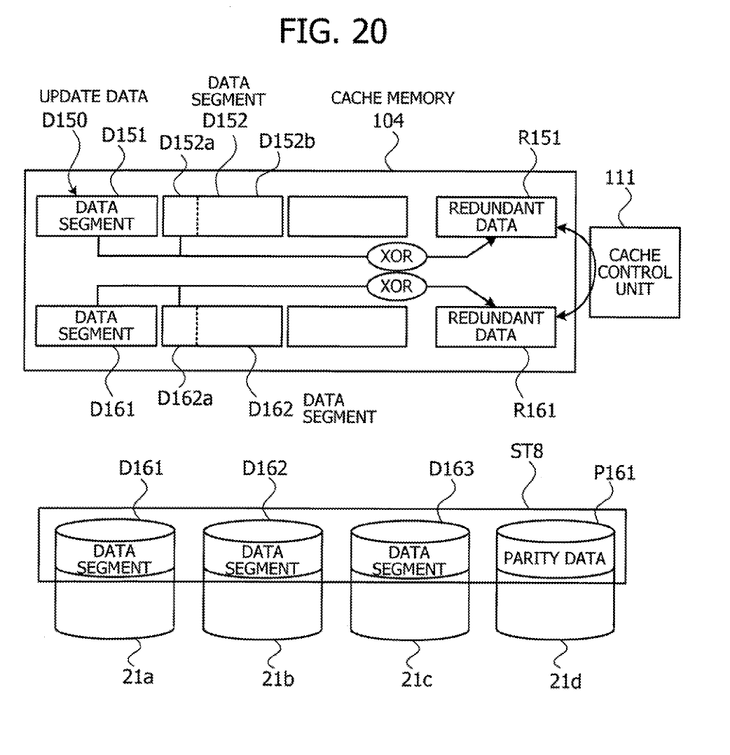

FIG. 20 illustrates a specific example of the first write decision routine using a second small-write scheme As seen in FIG. 20, a stripe ST8 is formed from storage spaces distributed across four different HDDs 21a to 21d. These storage spaces of stripe ST8 accommodate three data segments D161 to D163, together with parity data P161 for ensuring their redundancy.

The cache memory 104, on the other hand, stores data segments D151 and D152, which have been produced by the cache control unit 111 from given update data D150. The cache control unit 111 has also found that a differential write-back method is specified for that update data D150. It is noted that the latter data segment D152 is divided into two data subsegments D152a and D152b. The former data subsegment D152a is to partly update an existing data segment D162 (described below) as part of the target data, whereas the latter data subsegment D152b is formed from zero-valued bits.

The cache memory 104 also stores a data segment D161 and a data subsegment D162a that constitute target data corresponding to the data segment D151 and data subsegment D152a mentioned above. The data subsegment D162a is a part of the data segment D162.

The cache control unit 111 calculates XOR of the data segment D151 and data subsegment D152a of update data D150, thereby producing redundant data R151 for ensuring their redundancy. The cache control unit 111 keeps the produced redundant data R151 in the cache memory 104. The cache control unit 111 also calculates XOR of the existing data segment D161 and data subsegment D162a in the cache memory 104, thereby producing another piece of redundant data R161 for ensuring their redundancy. The cache control unit 111 keeps the produced redundant data R161 in the cache memory 104.

The cache control unit 111 then determines whether the former redundant data R151 coincides with the latter redundant data R161. If those two pieces of redundant data R151 and R161 coincide with each other, the cache control unit 111 determines not to write data segments D151 and data subsegment D152a to storage spaces of stripe ST8 in HDDs 21a to 21d. If any difference is found between the two pieces of redundant data R151 and R161, the cache control unit 111 writes the data segment D151 and data subsegment D152a into relevant storage spaces of stripe ST8 in HDDs 21a to 21d by using a second small-write scheme. For details of the second small-write scheme, see the foregoing description of FIG. 6.

(b17) Example of Second Write Decision Routine Using Bandwidth-Write Scheme

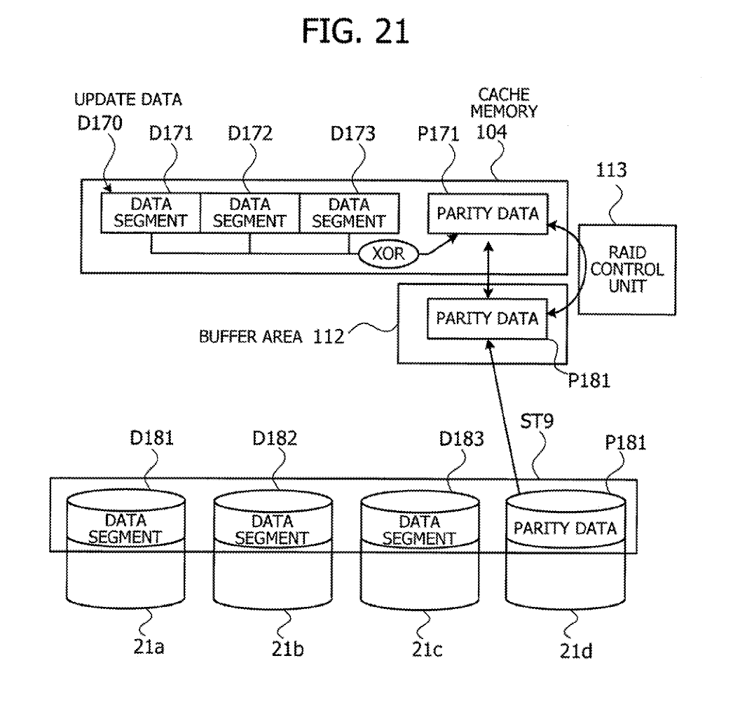

FIG. 21 illustrates a specific example of the second write decision routine using a bandwidth-write scheme. The cache memory 104 stores data segments D171, D172, and D173 that the cache control unit 111 has produced from given update data D170 with a size of one stripe. The cache control unit 111 has also found that a differential write-back method is specified for that update data D170. As seen in FIG. 21, a stripe ST9 is formed from storage spaces distributed across four different HDDs 21a to 21d. These storage spaces of stripe ST9 accommodate three data segments D181, D182, and D183, together with parity data P181 for ensuring their redundancy. These data segments D181, D182, and D183 are target data corresponding to the data segments D171, D172, and D173, respectively.

The RAID control unit 113 calculates XOR of the data segments D171, D172, and D173 of update data, thereby producing their parity data P171. The cache control unit 111 keeps the produced parity data P171 in the cache memory 104. The RAID control unit 113 then retrieves parity data P161 and stores it in a buffer area 112. The RAID control unit 113 determines whether the produced parity data P171 coincides with the parity data P181 in the buffer area 112. If those two pieces of parity data P171 and P181 coincide with each other, the RAID control unit 113 determines not to write the data segments D171, D172, and D173 to storage spaces of stripe ST9 in HDDs 21a to 21d. If any difference is found between the two pieces of parity data P171 and P181, then the RAID control unit 113 writes the data segments D171, D172, and D173 to their relevant storage spaces of stripe ST9 in HDDs 21a to 21d by using a bandwidth-write scheme. For details of the bandwidth-write scheme, see the foregoing description of FIG. 3.

(b18) Example of Second Write Decision Routine Using Read & Bandwidth-Write Scheme

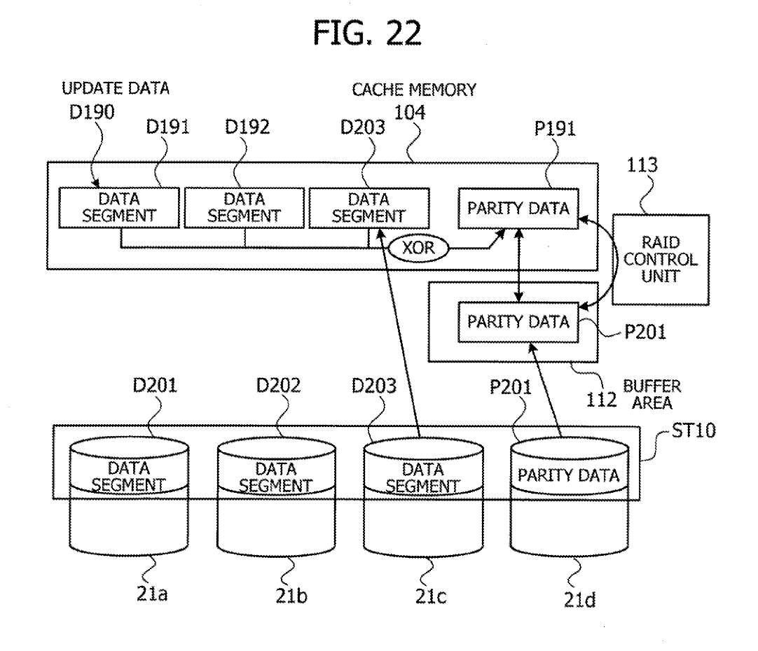

FIG. 22 illustrates a specific example of the second write decision routine using a read & bandwidth-write scheme. The cache memory 104 stores data segments D191 and D192, which have been produced by the cache control unit 111 from given update data D190. The cache control unit 111 has also found that a differential write-back method is specified for that update data D190. As seen in FIG. 22, a stripe ST10 is formed from storage spaces distributed across four different HDDs 21a to 21d. These storage spaces of stripe ST10 accommodate three data segments D201, D202, and D203, together with parity data P201 for ensuring their redundancy. The first two data segments D201 and D202 are regarded as target data of data segments D191 and D192, respectively.

The RAID control unit 113 retrieves a data segment D203 from the HDD 21c and stores it in the cache memory 104. The RAID control unit 113 also retrieves parity data P201 from the HDD 21d and keeps it in a buffer area 112. The RAID control unit 113 then calculates XOR of the data segments D191 and D192 of update data and the data segments D203 retrieved from the HDD 21c, thereby producing parity data P191 for ensuring their redundancy. The RAID control unit 113 keeps the produced parity data P191 in the cache memory 104.

The RAID control unit 113 determines whether the produced parity data P191 coincides with the retrieved parity data P201 in the buffer area 112. If those two pieces of parity data P191 and P201 coincide with each other, the RAID control unit 113 determines not to write data segments D191 and D192 to storage spaces of stripe ST10 in HDDs 21a to 21d. If the two pieces of parity data P191 and P201 are found to be different, the RAID control unit 113 writes the data segments D191 and D192 and parity data D191 into their relevant storage spaces of stripe ST10 in HDDs 21a to 21d by using a read & bandwidth-write scheme. For details of the read & bandwidth-write scheme, see the foregoing description of FIG. 4.

(b19) Example of Second Write Decision Routine Using First Small-Write Scheme

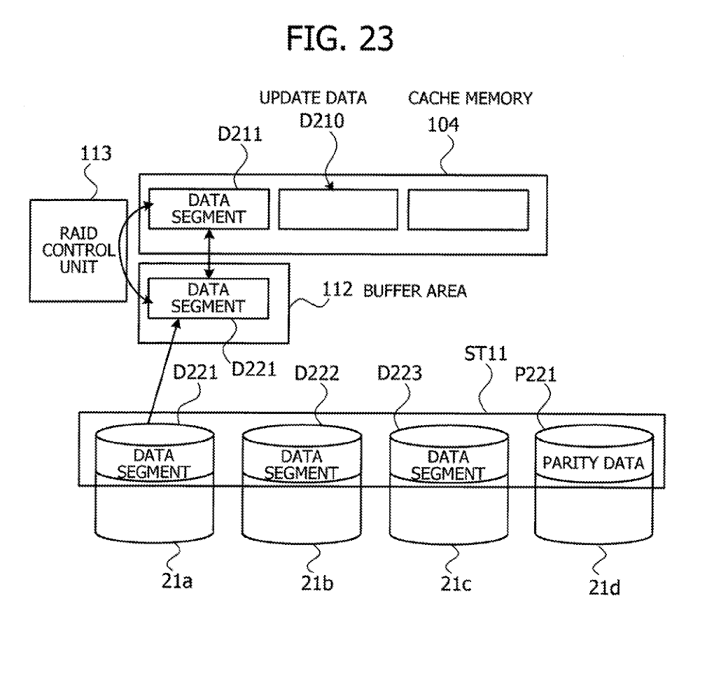

FIG. 23 illustrates a specific example of the second write decision routine using a first small-write scheme. The cache memory 104 stores a data segment D211, which has been produced by the cache control unit 111 from given update data D210. The cache control unit 111 has also found that a differential write-back method is specified for that update data D210. As seen in FIG. 23, a stripe ST11 is formed from storage spaces distributed across four different HDDs 21a to 21d. These storage spaces of stripe ST11 accommodate three data segments D221, D222, and D223, together with parity data P221 for ensuring redundancy of those data segments D221 to D223. Data segment D221 is regarded as target data of data segment D211.

The RAID control unit 113 retrieves data segment D221 from its storage space in the HDD 21a, a part of target stripe ST11 to which new data segment D211 is directed. The RAID control unit 113 keeps the retrieved data segment D221 in a buffer area 112. The RAID control unit 113 determines whether the produced data segment D211 of update data coincides with the retrieved data segment D221 in the buffer area 112. If those two data segments D211 and D221 coincide with each other, the RAID control unit 113 determines not to write data segment D211 to any storage spaces of stripe ST11 in HDDs 21a to 21d. If any difference is found between the two data segments D211 and D221, then the RAID control unit 113 writes data segment D211, together with new parity data (not illustrated), into relevant storage spaces of stripe ST11 in the HDDs 21a to 21d by using a first small-write scheme. For details of the first small-write scheme, see the foregoing description of FIG. 5.

(b20) Example of Second Write Decision Routine Using Second Small-Write Scheme

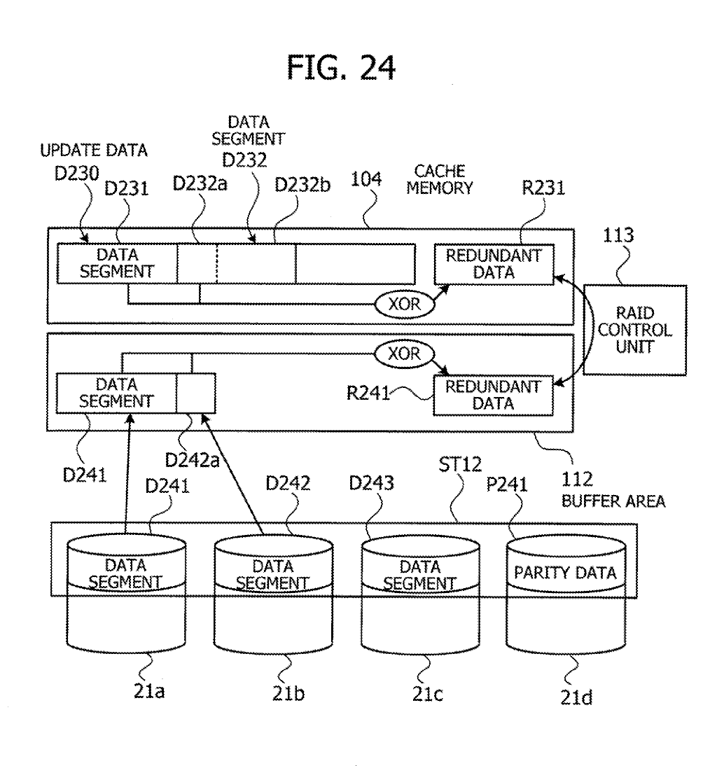

FIG. 24 illustrates a specific example of the second write decision routine using a second small-write scheme. As seen in FIG. 24, a stripe ST12 is formed from storage spaces distributed across four different HDDs 21a to 21d. These storage spaces of stripe ST12 accommodate three data segments D241, D242, and D243, together with parity data P241 for ensuring their redundancy. The cache memory 104 stores data segments D231 and D232, which have been produced by the cache control unit 111 from given update data D230. The cache control unit 111 has also found that a differential write-back method is specified for that update data D230. It is noted that the latter data segment D232 is divided into two data subsegments D232a and D232b. The former data subsegment D232a is to partly update the existing data segment D242 as part of the target data, whereas the latter data subsegment D232b is formed from zero-valued bits. Data segment D241 and data subsegment D242a are regarded as target data of data segments D231 and D232.

The RAID control unit 113 then calculates XOR of data segment D231 and data subsegment D232a produced from the update data, thereby producing redundant data R231 for ensuring their redundancy. The RAID control unit 113 keeps the produced redundant data R231 in the cache memory 104. The RAID control unit 113 also retrieves data segment D241 from its storage space in the HDD 21a, to which the new data segment D231 is directed. The RAID control unit 113 further retrieves data subsegment D242a from its storage space in the HDD 21b, to which the new data segment D232 is directed. This data subsegment D242a corresponds to data subsegment D232a. The RAID control unit 113 keeps the retrieved data segment D241 and data subsegment D242a in a buffer area 112. The RAID control unit 113 calculates XOR of the retrieved data segment D241 and data D242a, thereby producing redundant data R241. The RAID control unit 113 keeps the produced redundant data R241 in the buffer area 112.

The RAID control unit 113 then determines whether redundant data R231 coincides with redundant data R241. If those two pieces of redundant data R231 and R241 coincide with each other, the RAID control unit 113 determines not to write data segment D231 and data subsegment D232a to storage spaces of stripe ST12 in HDDs 21a to 21d. If any difference is found between the two pieces of redundant data R231 and R241, then the RAID control unit 113 writes data segment D231 and data subsegment D232a to their relevant storage spaces of stripe ST12 in HDDs 21a to 21d by using a second small-write scheme. For details of the second small-write scheme, see the foregoing description of FIG. 6.

As can be seen from the above description, the proposed storage apparatus 100 includes a cache control unit 111, as part of its controller module 10a. This cache control unit 111 determines whether a differential write-back method is specified for received update data, and if so, then determines whether the target data resides in a cache memory 104. The storage apparatus 100 also includes a RAID control unit 113 that executes a second write decision routine when there is no relevant data in the cache memory 104. Where appropriate, this second write decision routine avoids writing update data to storage spaces constituting the target stripe in HDDs 21a to 21d. Accordingly, the second write decision routine reduces the frequency of write operations to HDDs 21a to 21d.

Some data in the HDDs 21a to 21d may be retrieved during the second write decision routine. Since reading data from HDDs 21a to 21d is faster than writing data to HDDs 21a to 21d, the controller module 10a may be able to handle received update data in a shorter time by using the second write decision routine, i.e., not always writing update data, but doing it only in the case where the cache memory 104 contains no relevant entry for the update data.

The RAID control unit 113 calculates XOR of data segments to produce parity data or redundant data for comparison. The comparison using such parity data and redundant data achieves the purpose in a single action, in contrast to comparing individual data segments multiple times. The parity data and redundant data may be as large as a single data segment. This reduction in the total amount of compared data consequently alleviates the load on the CPU 101.

When update data is subject to a bandwidth-write scheme, the first write decision routine and second write decision routine compare existing parity data with new parity data of the update data. If the existing parity data does not coincide with the new parity data, the new parity data for ensuring redundancy of the update data is readily written into a relevant storage space of the target stripe in HDDs 21a to 21d. While other data (e.g., hash values) may similarly be used for comparison, the above use of parity data is advantageous because there is no need for newly generating parity data when the comparison ends up with a mismatch. This means that the controller module 10a handles update data in a shorter time.

According to the above-described embodiments, the storage apparatus 100 uses HDDs 20 as its constituent storage media. Some or all of those HDDs 20 may, however, be replaced with SSDs. When this is the case, the above-described embodiments reduce the frequency of write operations to SSDs, thus elongating their lives (i.e., the time until they reach the maximum number of write operations).

The functions of controller modules 10a and 10b may be executed by a plurality of processing devices in a distributed manner. For example, one device serves as the cache control unit 111 while another device serves as the RAID control unit 113. These two devices may be incorporated into a single storage apparatus.

Some functions of the proposed controller module 10a may be applied to accelerate the task of copying a large amount of data to backup media while making partial changes to the copied data. The next section will describe an apparatus for copying data within a storage apparatus 100 as an example application of the second embodiment.

### (c) Example Applications

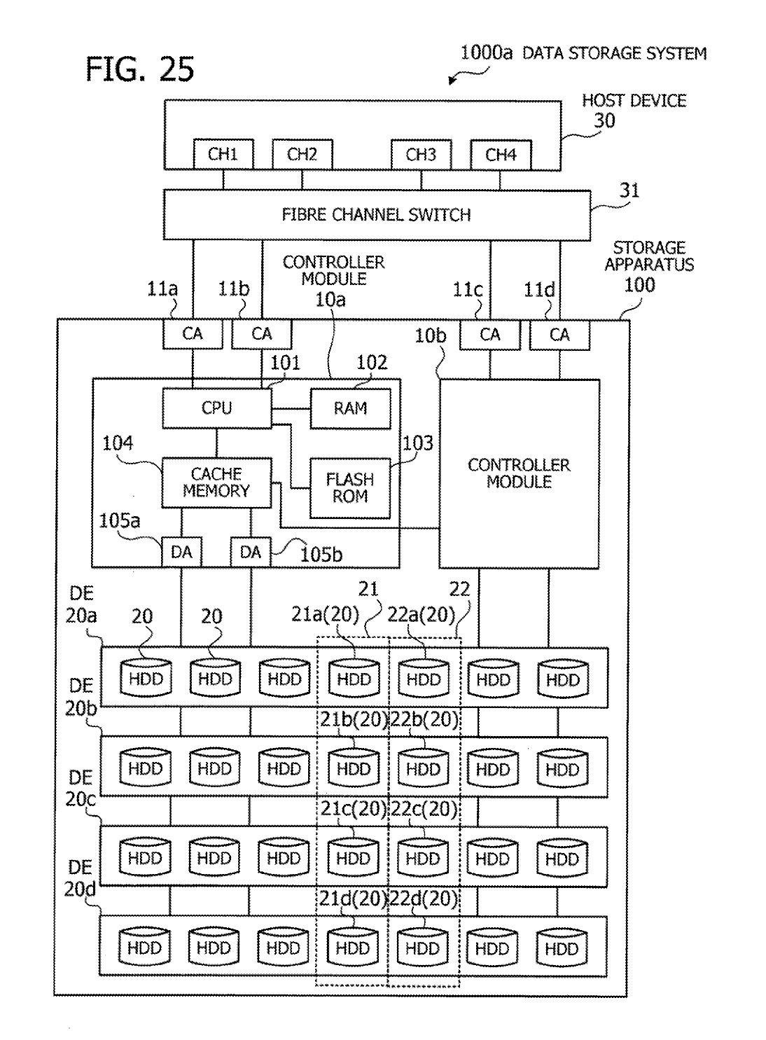

FIG. 25 illustrates an example application of the storage apparatus according to the second embodiment. The illustrated data storage system 1000a includes an additional RAID group 22. This RAID group 22 is formed from HDDs 22a, 22b, 22c, and 22d and operates as a RAID 5 (3+1) system.

In the illustrated data storage system 1000a, the storage apparatus 100 executes data copy from one RAID group 21 to another RAID group 22. This data copy is referred to hereafter as “intra-enclosure copy.” In the present implementation, the data stored in the former RAID group 21 may be regarded as update data, and the data stored in the latter RAID group 22 may be regarded as target data. Intra-enclosure copy may be executed by the storage apparatus 100 alone, without intervention of CPU in the host device 30. Data is copied from a successive series of storage spaces in the source RAID group 21 to those in the destination RAID group 22.

For example, the intra-enclosure copy may be realized by using the following methods: deduplex & copy method, background copy method, and copy-on-write method. These methods will now be outlined in the stated order.

(c1) Deduplex & Copy

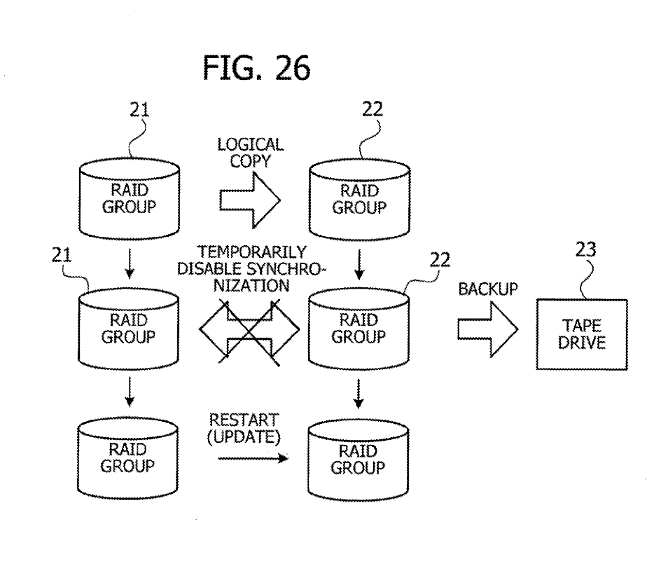

FIG. 26 illustrates a deduplex & copy method. The deduplex & copy method performs a logical copy operation while keeping the two RAID groups 21 and 22 in a duplexed (synchronized) state. Logical copy is a copying function used in a background copy method. Specifically, an image (or point-in-time snapshot) of the first RAID group 21 is created at the moment when the copying is started. A backup completion notice is also sent back to the requesting host device 30 at that moment. The logical copy is followed by physical copy, during which substantive data of the first RAID group 21 is copied to the second RAID group 22.

When starting backup of the second RAID group 22, the two RAID groups 21 and 22 are released from their synchronized state. While being detached from the first RAID group 21, the second RAID group 22 contains the same set of data as the first RAID group RAID group 21 at that moment. The second RAID group 22 may then be subjected to a process of backing up data to a tape drive 23 or the like, while the first RAID group 21 continues its service.

The two RAID groups 21 and 22 may be re-synchronized later. In that case, a differential update is performed to copy new data from the first RAID group 21 to the second RAID group 22.

(c2) Background Copy

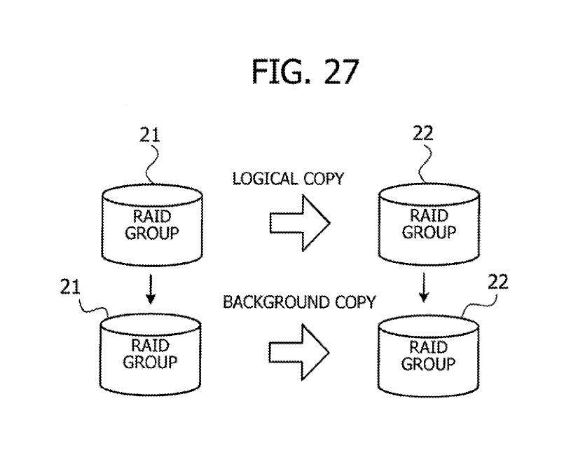

FIG. 27 illustrates a background copy method. Background copy is a function of creating at any required time a complete data copy of one RAID group 21 in another RAID group 22. Initially the second RAID group 22 is disconnected from (i.e., not synchronized with) the first RAID group 21. Accordingly none of the updates made to the first RAID group 21 are reflected in the second RAID group 22. When a need arises for copying the first RAID group 21, a logical copy is made from the RAID group 21 to the second RAID group 22. The data in the second RAID group 22 may then be backed up in a tape drive or the like without the need for waiting for completion of physical copying, while continuing service with the first RAID group 21.

(c3) Copy-on-Write

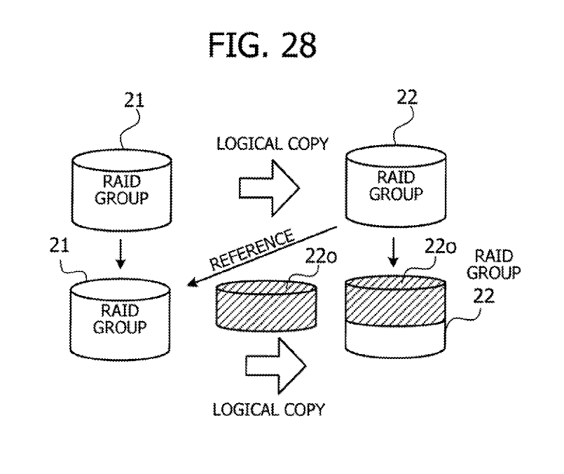

FIG. 28 illustrates a copy-on-write method. Copy-on-write is a function of creating a copy of original data when an update is made to that data. Specifically, when there is an update to the second RAID group 22, a reference is made to its original data 22o. This original data 22o is then copied from the first RAID group 21 to the second RAID group 22. Copy-on-write thus creates a partial copy in the second RAID group 22 only when that part is modified. Accordingly the second RAID group 22 has only to allocate storage spaces for the modified part. In other words, the second RAID group 22 needs less capacity than in the case of the above-described deduplex & copy or background copy.

According to the present example application, the controller modules 10a and 10b use the above-outlined three copying methods in duplicating data from the first RAID group 21 to the second RAID group 22. Particularly the controller modules 10a and 10b are configured to execute steps S2 to S5 of FIG. 8 to avoid overwriting existing data in the second RAID group 22 with the same data. This implementation of steps S2 to S5 of FIG. 8 may increase the chances of finishing the task of copying data in a shorter time.

The above-described example application is directed to intra-enclosure copying from the first RAID group 21 to the second RAID group 22. The second RAID group 22 may not necessarily be organized as a RAID-5 system. The second RAID group 22 may implement other RAID levels, or may even be a non-RAID system. The foregoing steps S2 to S5 of FIG. 8 may be applied not only to intra-enclosure copy as in the preceding example application, but also to enclosure-to-enclosure copy from, for example, the storage apparatus 100 to other storage apparatus (not illustrated).

The above sections have exemplified several embodiments of a control apparatus, control method, and storage apparatus, with reference to the accompanying drawings. It is noted, however, that the embodiments are not limited by the specific examples discussed above. For example, the described components may be replaced with other components having equivalent functions or may include other components or processing operations. Where appropriate, two or more components and features provided in the embodiments may be combined in a different way.

The above-described processing functions may be implemented on a computer system. In that case, the instructions describing processing functions of the foregoing control apparatus 3 and controller modules 10a and 10b are encoded and provided in the form of computer programs. A computer executes these programs to provide the processing functions discussed in the preceding sections. The programs may be encoded in a computer-readable medium for the purpose of storage and distribution. Such computer-readable media include magnetic storage devices, optical discs, magneto-optical storage media, semiconductor memory devices, and other tangible storage media. Magnetic storage devices include hard disk drives, flexible disks (FD), and magnetic tapes, for example. Optical discs include, for example, digital versatile disc (DVD), DVD-RAM, compact disc read-only memory (CD-ROM), and CD-Rewritable (CD-RW). Magneto-optical storage media include magneto-optical discs (MO), for example.

Portable storage media, such as DVD and CD-ROM, are used for distribution of program products. Network-based distribution of software programs may also be possible, in which case several master program files are made available on a server computer for downloading to other computers via a network.

For example, a computer stores necessary software components in its local storage device, which have previously been installed from a portable storage medium or downloaded from a server computer. The computer executes programs read out of the local storage unit to perform the programmed functions. Where appropriate, the computer may execute program codes read out of a portable storage medium, without installing them in its local storage device. Another alternative method is that the user computer dynamically downloads programs from a server computer when they are demanded and executes them upon delivery.

The processing functions discussed in the preceding sections may also be implemented wholly or partly by using a digital signal processor (DSP), application-specific integrated circuit (ASIC), programmable logic device (PLD), or other electronic circuit.

As can be seen from the above disclosure, the proposed control apparatus, control method, and storage apparatus reduce the frequency of write operations to data storage media.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A control apparatus for controlling data write operations to a storage medium, the control apparatus comprising:
a cache memory configured to store a temporary copy of first data written in the storage medium; and
a processor configured to perform a procedure comprising
receiving second data with which the first data in the storage medium is to be updated,
determining, upon reception of the second data, whether the received second data coincides with the first data, based on comparison data read out of the storage medium, when no copy of the first data is found in the cache memory, and
determining not to write the second data into the storage medium when the second data is determined to coincide with the first data.

2. The control apparatus according to claim 1, wherein
the storage medium coupled to the control apparatus comprises a plurality of constituent storage media;
the first data is divided into a plurality of first data segments, and the first data segments are stored, together with first redundant information for ensuring redundancy of the first data segments, in the plurality of constituent storage media in a distributed manner; and
the determining of whether the received second data coincides with the first data comprises
dividing the second data into a plurality of second data segments, producing second redundant information for ensuring redundancy of the second data segments, and
determining whether the first redundant information coincides with the second redundant information.

3. The control apparatus according to claim 2, wherein
the first redundant information is parity data of the first data segments, and the second redundant information is parity data of the second data segments; and
the procedure further comprises updating the first data segments and the first redundant information in the storage media with the second data segments and the second redundant information, when the first redundant information is determined to be different from the second redundant information.

4. The control apparatus according to claim 3, wherein the procedure further comprises, when the second data is to update a part of the first data segments distributed in the storage media, but not to update the other part of the first data segments, reading the other part of the first data segments out of the storage media to produce the first redundant information.

5. The control apparatus according to claim 1, wherein the procedure further comprises writing the second data into the storage medium when the second data does not coincide with the first data.

6. The control apparatus according to claim 1, wherein the procedure further comprises reading the comparison data from the storage medium when the cache memory contains no temporary copy of the first data.

7. The control apparatus according to claim 1, the procedure further comprising determining, when the cache memory contains a temporary copy of the first data, whether the second data coincides with the first data in the cache memory.

8. The control apparatus according to claim 7, wherein the determining of whether the second data coincides with the first data in the cache memory comprises:
dividing the first data cached in the cache memory into a plurality of first data segments;
producing first redundant information for ensuring redundancy of the first data segments;
dividing the second data into a plurality of second data segments;
producing second redundant information for ensuring redundancy of the second data segments; and
determining whether the produced first redundant information coincides with the produced second redundant information.

9. The control apparatus according to claim 8, wherein
the storage medium coupled to the control apparatus comprises a plurality of constituent storage media;
the first data is divided into a plurality of first data segments, and the first data segments are stored, together with first redundant information for ensuring redundancy of the first data segments, in the plurality of storage media in a distributed manner; and
the first redundant information is parity data of the first data segments, and the second redundant information is parity data of the second data segments;
the procedure further comprises updating the first data segments and the first redundant information in the storage media with the second data segments and the second redundant information, when the first redundant information is determined to be different from the second redundant information.

10. A method executed by a computer for controlling write operations to a storage medium, the method comprising:
receiving second data with which the first data in the storage medium is to be updated;
determining, upon reception of the second data, whether the received second data coincides with the first data, based on comparison data read out of the storage medium, when no copy of the first data is found in the cache memory; and
determining not to write the second data into the storage medium when the second data is determined to coincide with the first data.

11. A storage apparatus comprising:
a storage medium configured to store data; and
a control apparatus configured to control write data operations to the storage medium, the control apparatus comprising
a cache memory configured to store a temporary copy of first data written in the storage medium, and
a processor configured to perform a procedure comprising
receiving second data with which the first data in the storage medium is to be updated,
determining, upon reception of the second data, whether the received second data coincides with the first data, based on comparison data read out of the storage medium, when no copy of the first data is found in the cache memory, and
determining not to write the second data into the storage medium when the second data is determined to coincide with the first data.
